(19) United States
(12) Patent Application Publication
(10) Pub. No.: US 2025/0277311 A1
(43) Pub. Date: Sep. 4, 2025

(54) SYSTEM AND METHOD FOR ELECTROCHEMICAL ADDITIVE MANUFACTURING

(71) Applicant: The Research Foundation for The State University of New York, Binghamton, NY (US)

(72) Inventors: Scott N. Schiffres, Vestal, NY (US); Azad Hussein, Endicott, NY (US)

(21) Appl. No.: 19/067,989

(22) Filed: Mar. 2, 2025

Related U.S. Application Data
(60) Provisional application No. 63/560,662, filed on Mar. 2, 2024.

(51) Int. Cl. C23C 18/16; B33Y 10/00; B33Y 70/10; B33Y 80/00

(52) U.S. Cl. CPC C23C 18/1651; C23C 18/1642; C23C 18/1648; B33Y 10/00; B33Y 70/10; B33Y 80/00

(57) ABSTRACT

A structure, comprising a strike layer on a thermally dissipative substrate, having a conductive surface; and a spatially-selective electrochemically bonded composite structure, containing inclusions bonded to a matrix of the electrochemically bonded composite structure. The matrix of the electrochemically bonded composite structure may be a metal, and the inclusions comprise solid particles of metal or high thermal conductivity non-metal. The particles may increase the thermal transfer rate and/or reduce the coefficient of thermal expansion of the electrochemically bonded composite structure.

### CROSS REFERENCE TO RELATED APPLICATIONS

The present application is a Non-Provisional of, and claims benefit of priority under 35 U.S.C. § 119 (e) from, U.S. Provisional Patent Application No. 63/560,662, filed Mar. 2, 2024, the entirety of which is expressly incorporated herein by reference.

### STATEMENT OF GOVERNMENT INTEREST

The invention was made with U.S. government support under National Science Foundation CBET award 1846157, and Department of Energy ARPAE award 14000780. The U.S. government has certain rights in the invention.

### FIELD OF THE INVENTION

The present invention relates to the field of additive manufacturing (“AM”) by electrochemical methods. It is of particular application to cooling devices onto electronic devices, lids and or heat spreaders, resulting in a fabricated product comprising a cooling device or external metal device.

### INCORPORATION BY REFERENCE AND INTERPRETATION OF LANGUAGE

Citation or identification of any reference herein, in any section of this application, shall not be construed as an admission that such reference is necessarily available as prior art to the present application. The disclosures of each reference disclosed herein, whether U.S. or foreign patent literature, or non-patent literature, are hereby incorporated by reference in their entirety in this application, and shall be treated as if the entirety thereof forms a part of this application.

All cited or identified references are provided for their disclosure of technologies to enable practice of the present invention, to provide basis for claim language, and to make clear applicant's possession of the invention with respect to the various aggregates, combinations, and subcombinations of the respective disclosures or portions thereof (within a particular reference or across multiple references). The citation of references is intended to be part of the disclosure of the invention, and not merely supplementary background information. The incorporation by reference does not extend to teachings which are inconsistent with the invention as expressly described herein (which may be treated as counter examples), and is evidence of a proper interpretation by persons of ordinary skill in the art of the terms, phrase and concepts discussed herein, without being limiting as the sole interpretation available.

The present specification is not to be interpreted by recourse to lay dictionaries in preference to field-specific dictionaries or usage. Where a conflict of interpretation exists, the hierarchy of resolution shall be the express specification, references cited for propositions, incorporated references generally, the inventors' prior publications relating to the field, academic literature in the field generally, commercial literature in the field, field-specific dictionaries, lay literature in the field, general purpose dictionaries, and common understanding.

### BACKGROUND OF THE INVENTION

The heat fluxes in electronic chips, especially the ones used in data centers, are increasing drastically every year with maximum thermal design powers (TDPs) of 350 W for CPUs and 750 for GPUs. One of the methods of cooling such chips is via two-phase immersion or forced liquid convection cooling. In such systems, part of the package (the chip itself) or the entire server (chip with motherboard and components) comes into contact with a liquid. With many dielectric fluids, the chip cools down via boiling heat transfer. Currently, plates with boiling enhancement coatings (sintered copper) are used for such configurations as heat sinks. However, before the heat reaches the surface of the boiling enhancement plate, it has to pass the thermal interface material (TIM) 1, internal heat spreader (IHS), and TIM 2, which each add to the thermal resistance. Furthermore, there is not much freedom of design in such boiling enhancement plates due to their current manufacturing method.

Removing the two thermal interfaces reduces the thermal resistances. Prior work looked at removing thermal interfaces by printing structures onto the chip, which can enable the removal of the thermal interface material 1 (“TIM1”) and thermal interface material 2 (“TIM2”) (US 2022/0055153A1, U.S. patent application Ser. No. 18/318,670, US Prov. App. PTO 63/468,228, US Prov. App. Prov. Application 63/534,648). This solution is promising, but requires new methods of manufacturing. A method to print beneficial designs while minimizing additive printing is beneficial owing to AM's relatively high expense.

Prior art for electrochemical additive methods in the literature take several forms. One method selectively electroplates by using an electroplating donor plate that has a photolithographic mask that covers the donor with an electrically insulating layer. Each layer is printed using two materials a desired material and sacrificial material. After each layer, a polishing step is used. Following the build-up of a 3D structure, the sacrificial material (e.g., Pb) is etched away (U.S. Pat. No. 9,512,532, Microfabrica). Other electrochemical methods use a small stylus (e.g., atomic force microscopy AFM stylus) to selectively electroplate near the AFM tip onto a conductive substrate. Some methods selectively electroplate using an array of electrodes that selectively turn on (e.g., like the AFM tip method by parallelized) with electrolyte solution flowing across the selective electrodes (U.S. Pat. No. 10,465,307, Fabric8). Various aspects of the present technology can advantageously be used with known systems and methods of the prior art discussed herein.

The present technology provides more efficient cooling of the electronic chip by reducing the thermal resistances in addition to innovative designs for boiling enhancement via hybrid additive manufacturing techniques.

Electroplating is a process in which a metallic coating is deposited onto a conductive substrate by applying an electric current through an electrolyte solution. The substrate, acting as the cathode, gains a metal layer that grows in thickness while maintaining conductivity. If the deposited element is non-metallic, it may form an insulating layer rather than a continuous conductive coating. Meanwhile, the anode, often made of the same metal being plated, can undergo oxidation, releasing metal ions into the solution. In some cases, anodes may develop non-conductive oxides or ceramic-like films that limit their effectiveness, requiring materials resistant to such formations.

Electroplating, also referred to as electrodeposition, is a method used to enhance surfaces with metal coatings by reducing metal cations from an electrolyte bath. The metal to be deposited is present in solution as positively charged ions, which migrate to the negatively charged cathode and are reduced to a metallic form. The anode, typically composed of the same metal as the deposit or an inert conductive material, may either dissolve to replenish ions in the solution or remain unchanged while the electrolyte is periodically refreshed. The process is powered by an external electrical source.

A variation of electroplating, known as anodizing, operates under reversed polarity, where oxidation rather than reduction occurs at the working electrode. This method is commonly used to form protective oxide layers on metals such as aluminum, or to create silver chloride coatings on silver electrodes for specialized applications.

For successful plating, the electrolyte must contain metal ions that will be deposited onto the substrate. For example, in copper electroplating, copper (II) sulfate is used as the electrolyte, providing Cu²⁺ ions that are reduced at the cathode into solid copper. When the anode is made of copper, it undergoes oxidation, dissolving into Cu²⁺ ions and maintaining the solution's metal concentration. If an inert anode is used, oxidation may produce oxygen, hydrogen peroxide, or other byproducts, requiring periodic replenishment of metal ions in the bath.

Most electroplating applications involve the deposition of a single metallic element rather than an alloy. However, some alloys, such as brass and solder, can be electroplated, though they typically form as microscopic mixtures of individual metal crystals rather than true solid solutions. In some cases, plated solder is melted to form a homogenous alloy, improving its corrosion resistance.

To prevent unwanted deposition, specific areas of the substrate can be masked using stop-off materials such as tape, lacquers, or waxes. Additionally, a preliminary thin layer, known as a strike or flash coating, is sometimes applied to improve adhesion. This initial layer is deposited under specific conditions of high current density and low ion concentration before standard electroplating continues. Strike coatings are particularly useful when transitioning between metals with poor adhesion properties, such as nickel on zinc alloys, where an intermediary copper strike enhances bonding.

An advanced electroplating technique, known as pulse electroplating or pulse electrodeposition (PED), modulates the electrical current or potential in short pulses rather than maintaining a steady flow. By adjusting parameters such as pulse duration and frequency, this method enables better control over film composition, thickness, and internal stress. High-frequency, short-duration pulses help minimize defects such as surface cracks, leading to improved coating quality.

Sec, en.wikipedia.org/wiki/Electroplating

### Electroless Deposition and Immersion Coating

Electroless deposition is a plating method that does not require an external electrical current. Instead, it relies on chemical reduction reactions in a solution containing metal ions and a reducing agent. This process is autocatalytic, meaning that once metal starts depositing onto the substrate, the reaction sustains itself, allowing uniform coating growth. Electroless plating is widely used for depositing nickel-phosphorus, nickel-boron, and copper coatings, particularly on non-conductive materials such as plastics, ceramics, and glass. Unlike electroplating, which requires conductive substrates, electroless deposition can coat complex three-dimensional structures uniformly, even inside cavities. However, it generally has a slower deposition rate and requires precise chemical control.

Another metal deposition technique, immersion coating, uses a displacement reaction to form a thin metal layer on a substrate. In this process, metal ions in solution are reduced and deposited onto the substrate, while the substrate metal dissolves into the electrolyte. This method produces very thin coatings since deposition halts once the surface is fully covered. A well-known application is the electroless nickel immersion gold (ENIG) process, used for gold-plating electrical contacts on printed circuit boards.

### Key Stages of Electroless Deposition

Electroless deposition typically involves four main steps:

Pretreatment—The substrate is cleaned to remove contaminants that could affect plating quality.

Sensitization—A catalyst or activator is applied to initiate metal deposition.

Activation—The deposition rate is enhanced by providing catalytic sites for metal reduction.

Deposition—Metal ions in solution are reduced to their elemental form by a chemical reducing agent, forming a metal film on the substrate.

This process is driven by redox chemistry, where electrons from the reducing agent are transferred to metal cations, resulting in metal deposition.

See, en.wikipedia.org/wiki/Electroless_deposition

Sec, en.wikipedia.org/wiki/Electroless_deposition

Electrochemical additive methods in the literature take several forms. Electrochemical additive methods incorporate several techniques to selectively electroplate. Some selectively electroplate by using an electroplating donor plate that has a photolithographic mask that covers the donor with electrically insulating layer (U.S. Pat. No. 9,512,532, Microfabrica).

Some selectively electroplate using an atomic force microscopy (“AFM”) tip to selectively write near the AFM tip. Some selectively electroplate using an array of electrodes that selectively turn on (e.g., like the AFM tip method by parallelized) with electrolyte solution flowing across the selective electrodes (U.S. Pat. No. 10,465,307, Fabric8). Some selectively electroplate with two materials, one of which can be selectively etched (used as sacrificial electrode) (U.S. Pat. No. 9,512,532, Microfabrica).

Electrochemical additive manufacturing has been proposed for production of heatsinks and other heat transfer structures.

Hengsteler et al. (158), discusses electrochemical additive manufacturing. Electrochemical methods permit processing of conductors, semiconductors, metals, metal oxides (13), conductive polymers (14, 15), and (conductive) biomolecules (16-18), and in a variety of material forms, including thin films (19), single crystals (20), nanoparticles (21), and composites (22, 23).

According to Hengsteler et al. (158), the primary advantage of electrochemistry for 3D printing is the possibility to convert liquid inks into solid materials via electrodeposition. The process fundamentally is rather simple, can be used for the AM of a range of materials, and offers a high degree of control of morphology and rate. It requires an electrochemical cell consisting of two or three electrodes and an electrolyte solution containing precursor species, e.g., metal ions, as well as a supporting electrolyte (inert salt to carry current) with sufficient conductivity. As the voltage needed to drive an electron transfer from the electrode surface to the precursor in solution is applied, the species are reduced into a solid. To adapt electrodeposition to AM, one should ensure that plating occurs only locally, at specified locations, and can be adapted to a layer-by-layer process. This is typically achieved via confinement, i.e., a localized delivery of precursor ions from a nozzle.

Hengsteler et al. (158) further describes that, one way of localizing electrodeposition is the manipulation of fluid flow. Fluidic force microscopy (FluidFM) (32-34) is an exemplary technology of this approach, where a microchanneled cantilever is connected to a microfluidic system to drive small amounts of precursor ink through a submicroscale or nanoscale opening at the pyramidal tip. To print a voxel, the cantilever is positioned a few hundreds of nanometers above the substrate, and the liquid ink jet hits the working electrode surface, where electrodeposition occurs.

Hengsteler et al. (158) describes that a similar, yet different type of e-AM in a liquid environment is based on scanning ion conductance microscopy (SICM) (35), a nanoelectrochemical imaging technique. In this case, the nozzle is a pulled glass capillary with opening dimensions ranging from several nanometers to microns, which operates by measuring the distance-dependent resistance in the gap between the tip and the substrate. The delivery principle differs slightly from FluidFM: Instead of liquid flow, the precursor ions are supplied by electromigration, induced by the applied voltage across the nozzle using a quasi-reference counter electrode (QRCE) (36, 37).

Hengsteler et al. (158) describes that meniscus-confined electrodeposition (MCED) (38-40) uses a drastically different principle to confine printing to a small area. In this case, electrodeposition is localized in a liquid meniscus, a droplet that forms between a nanopipette nozzle and a conductive substrate. The print nozzle is not immersed into liquid, and only a minute electrolyte droplet (somewhat close in diameter to the nozzle opening) limits the area where deposition can occur on the substrate. Printing starts immediately as the meniscus is formed and, continues as long as the cathodic voltage is applied, and requires a retraction of the nozzle to avoid clogging.

Hengsteler et al. (158) describes that electrohydrodynamic redox printing [EHD-RP (26)], unlike meniscus-confined techniques where the droplet forms a continuum with the rest of the electrolyte solution in the nanopipette, individual droplets are ejected from the nozzle positioned several microns away from the conductive surface. Droplets, typically in dimensions somewhat smaller than the nozzle opening size, are formed due to high (ca. 50-150 V) constant voltage applied to the wire inside the nozzle. The large electric field on the order of ˜10⁷ V m ⁻¹ helps to overcome the ink surface tension, while the sacrificial electrode wire oxidation supplies metal ions to the nozzle tip. Electrodeposition occurs when the ejected liquid lands on the conductive substrate and electron transfer converts the droplet content (ions) into a solid metal.

Hengsteler et al. (158) describes that the particularities of each technique provide a range of advantages or disadvantages in terms of resolution, print rates, and voxel shapes and arrangement. For example, printing in liquid environments with FluidFM or SICM is typically rather limited in resolution, allowing minimum feature sizes around 0.5 micrometers (25, 27, 36). EHD-RP is capable of about half of that for out-of-plane features (26), whereas MCED reaches a 25-nm resolution mark (24). Print rates are also substantially different because of the drastically different delivery mechanism, with FluidFM, SICM, and MCED approaching approximately 1 voxel s ⁻¹ and EHD-RP being fivefold faster. The performance in 3D printing, however, is also largely influenced by qualitative factors, such as the complexity of printed features and continuity of structures, which depend on voxel shapes and how the voxels are placed with respect to each other. In this regard, there is also a large distribution across e-AM methods, with in-liquid techniques such as FluidFM able to produce very complex features, with or without support structures, given by the possibility to place voxels in almost any arrangement. On the other end of the spectrum is meniscus-based printing, where voxels are typically straight pillars, which are more difficult to place in tighter structures to create other than column-like objects. EHD-RP is somewhat in the middle between these two extremes, meaning that various structures can be produced, but so far, the intricacy is limited to pillars or walls, or arches produced by etching a sacrificial (also 3D printed) layer.

Existing electrochemical additive techniques are promising, but the known templating electroplating systems were not optimized for mass production.

### SUMMARY OF THE INVENTION

Conventional heatsinks and lids are more economical per unit volume than current additively manufactured products. Conventional lids have smooth mating surfaces to silicon chips. Many OEM processor manufacturers sell their electrical devices with lids already in place. These lids serve multiple purposes: hermetic sealing, electromagnetic interference reduction, thermal heat spreading, and oxygen and humidity barriers. They also serve a mechanical purpose, to stiffen and prevent flexing induced failure of the electronic devices and interconnects.

Printing of cooling devices directly onto lids: (1) provides the benefits of additive manufacturing, (2) does not influence the reliability of conventionally packaged devices, and (3) eliminates the need to post-machine the printed design. The benefits of additive manufacturing for cooling devices includes free-form designs with lattices, high surface area, and integrated wicks. Additive manufacturing allows designs with higher surface areas. These high surface areas can take the form of lattices, gyroids, other high-surface area forms that vary spatially. For instance, fractal-like cold plate designs can be optimized for hotspots with various densities across the silicon or IHS. The benefit of using conventional lids/integrated heat spreaders (IHS) is that printing onto the lids/IHS will not negatively impact reliability, while obtaining the benefits of additively manufactured features. This printing onto the lid/IHS also allows lateral heat spreading. Most designs printed onto the lid will not significantly modify the stiffness and curvature of the lid. Moreover, not having a TIM2 between the heatsink and lid will remove multiple failure modes (i.e., non-uniform TIM deposition or compression, and material compatibility with dielectric fluids), and better cooling also leads to better reliability.

The benefit of printing a monolithic spreader is relatively lower than a printed heatsink on a conventionally manufactured lid, because metal printed material is more expensive, generally slightly lower thermal conductivity, and generally has higher roughness than conventional designs. Here lies the benefits of printing onto the lid/IHS. This eliminates the need for most post-processing, which is a benefit. The alternative, a fully printed heatsink would require machining of the heatsink-chip interfacing surface. The present technology uses additively manufactured material where it is of greatest benefit, which is more economical and better performing.

The printing of lattices onto a bare silicon chip achieves on the order of at least a two times higher maximum heat flux than the bare silicon chip in a two-phase immersion cooling test for a ˜1 cm² chip at 95 W TDP. These printed designs also have lower thermal resistance by ˜20%, with greater reduction possible.

The present technology also applies to printing directly onto the surface of an electronic substrate/chip post-manufacture and packaging. Technologies exist to print directly onto the lid, but the present technology also addresses how it can be used with electrochemical-based additive manufacturing, and done in a high-throughput manner for production environment.

The present technology provides several different embodiments. One embodiment enables direct electrochemical printing of 3D features onto a dissimilar substrate (e.g., printing of cooling features onto Si, SiC, GaN, ceramics, graphite, composites) (Summarized in FIG. 1). The robust connection is facilitated by three aspects that can be employed separately or in concert: (1) coefficient of thermal expansion (CTE) matching additives (FIG. 2), (2) ductile interlayers, and (3) stress reducing designs.

The present technology provides an inclusion-containing electrochemical additive produced additively manufactured materials that give desirable properties (e.g., higher thermal conductivity, or better matched CTE).

The present technology also covers various methods of electrochemical additive manufacturing. One particular method uses a printed polymer (stereolithographic method (SLA), fused deposition modeling (FDM), jetting, etc.) to make a template that is then electroplated from the bottom up, and then dissolving or otherwise removing the polymer material.

The present technology provides particular benefits for large wafer scale chips, like 8.5″×8.5″ wafer scale engines that are emerging for artificial intelligence (AI) applications.

These large-scale chips and heterogeneously integrated (HI) chips would benefit from the present cooling paradigms, as conventional cooling methods (e.g., lateral heat spreading) poorly scale to these larger silicon surface area devices.

The present technology would also be helpful for forming skylined cooling features that thermally connect two profiled surfaces. For instance, particularly in mobile applications, two electronic boards are positioned in proximity with a small gap that needs thermal bridging. An insert to thermally bridge the gap could be provided by the present technology.

The general method uses a form (e.g., positive mold) that can be molded, additively manufactured, or subtractively manufactured by conventional processes, and the form act as a template to be filled by electroplating. The electroplated solid is then coated in thermal bridging material and also electrical isolation material as needed. Similarly, a negative mold may be provided, and processed through a reversal step as necessary to provide the ultimate surface for electrochemical deposition. In some cases, an electroplated shell and/or fine features may be provided, supplemented by a bulk fill process with molten metal or a sintered metal process. This composite manufacturing therefore obtains the geometric advantages of the AM mold, with the speed efficiency of a non-electrochemical bulk space fill technology.

This skyline insert could be produced by machining or printing a mold template, inside which the electroplating will follow the exact contour of the skyline, or a contour minus a “margin layer”. The mold can be coated in a paintable elastomeric thermal interface coating (part of the “margin layer”), and then coated in an electrically conductive strike layer (also part of the “margin layer”) by means including painting an electrically conductive material, or electroless plating, and then electroplating the insert onto that. The strike layer, for example, improves adhesion between two dissimilar material layers. The strike layer may be formed in an electrolyte strike solution, that assists in formation of a quality initial strike layer, and after formation, the solution is changed (perhaps to form additional layers of the same material). The electroplating can be with high thermal conductivity materials, like copper or a metal-composite. In some implementations, the electroplating template can be a board of the device itself, where an ideally reworkable electrical isolating layer, followed by a conductive layer (e.g., conductive ink or glue) are applied, followed by electroplating. The electroplating bath can have a pumped flowing solution of electrolyte solution (“ink”) to improve kinetics.

The margin layer could be made out of a compliant material that serves as a thinner thermal interface material. The margin layer could also help electrically isolate electronics from electroplated form, as necessary. The first layer of the margin material proximal to the electronics can be electrically insulating. The margin material can be thickened to provide more elastomeric material to absorb more energy during shocks and vibrations from loads including dropping in case of mobile applications, or launch or landing for aerospace applications.

In some applications two separate templated skylines can be made in two halves (one for bottom board fit and one for top board fit) and then connected with a thin layer of thermal interface material (similar to the margin material). To get a good fit between the two halves, some material removal to achieve to flat surfaces of controlled thickness might be needed which can be achieved by methods including machining, abrasion and polishing.

It is possible to use several masks that are templated with the first n-layer pattern, and then transition to the next m-layer pattern, and so on. This templated/stencil system would have the benefit of a simpler structure that need not be addressable. The templates could be photolithographed to mask off non-printed regions. The template could be used as a donor plate, if it is made of the material to be deposited, or it could be made of something that acts as a counter electrode with electroplating metal entirely coming from solution (e.g., copper sulfate containing for Cu electroplating).

Single or multiple semiconductor device(s) or lid(s) may be electrochemically printed at once. Planarity and/or flatness might be an issue for certain electrochemical additive processes, as tight tolerances are required for some techniques (e.g., ˜1 micron).

The technology provides, according to one embodiment, a method for producing copper-diamond porous composites with enhanced thermal properties, comprising:

Preparation of Substrate: Preparing substrate by cleaning it with acetone to remove dust, grease, and impurities, and rendering it conductive through electroless plating or by applying a graphite paint layer. In some applications, the substrate will already be sufficiently conductive, and that conductive existing layer can be considered the strike, thus the additional deposition step can be skipped.

Electroplating Copper: Electroplating copper onto the conductive polymer substrate using a copper sulfate-based solution containing 240 g/L of copper sulfate pentahydrate (CuSO₄·5H₂O) and 46 g/L of sulfuric acid (H₂SO₄) to establish a base copper layer. In some applications, skipping this step might be beneficial.

Incorporation of Copper and Diamond Powders: Introducing copper powder, with a mean size of 40 μm and/or diamond particles coated with a conductive layer, into the electroplating bath, wherein the powders are dispersed evenly by stirring with a magnetic stirrer to ensure uniform distribution within the bath.

Layer-by-Layer Deposition: Depositing the copper and/or diamond powders onto the substrate by alternating stirring and plating intervals to embed the powders within the electroplated copper matrix, where electroplating is performed with a current density of 25 mA/cm².

Continuous Powder Addition: Periodically add additional copper powder to the electroplating bath at intervals of 5 hours to maintain continuous incorporation and ensure a uniform porous structure in the composite.

Formation of Composite Structure: Electroplating until the desired thickness and porosity, in the range of 30%-45%, is achieved, resulting in a copper composite in which the copper and diamond powder particles are uniformly distributed and strongly bonded within the matrix. The bonding process locks the otherwise free particles into fixed position, though in some cases, the particles may be compacted before bonding. The particles may be 5%, 10%, 15%, 20%, 25%, 30%, 35%, 40%, 45%, 50%, 55%, 50%, 65%, 70% or 75% by volume of inclusions. Typically, the metal matrix provides structural support and adhesion, as well as interfaces with the substrate and between the particles, and these functions therefore require some bulk metal to be achieved. On the other hand, higher loading with particles, especially thermally conductive particles, helps to achieve a heat transfer purpose. When CTE matching is desired, the particle loading may target the CTE match level, or nearly so.

Post-Electroplating Processing: Optionally sanding the electroplated composite to remove any exposed polymer material and achieve precise dimensions of the plated structure.

The substrate may be an additive-manufactured polymer structure with a customized design, which allows for targeted porosity and enhanced thermal dissipation when used in heat sink applications.

The diamond particles may be pre-treated through electroless plating or carbide coating to enhance conductivity or surface adhesion, before introduction into the electroplating bath.

The copper powder and coated diamond particles may be mixed in a variable ratio based on the thermal conductivity and mechanical strength requirements of the final composite. The ratios may change over the course of the process, to produce a gradient or other desired profile.

The electroplated composite may be further processed to form a customized geometry suitable for integration into electronic devices requiring advanced thermal management.

The polymer surface may be sanded after electroplating to remove any remaining polymer material and to achieve precise dimensions of the plated copper composite.

The technology therefore provides electrodeposited porous materials with solid inclusions, especially those formed using sedimentation and periodic electroplating pulses.

The technology may be used to deposit a spatially patterned composite material comprising an electrochemically deposited copper matrix having embedded diamond particles, for example deposited directly on a semiconductor wafer or on a lid of a packaged integrated circuit package. The composite material may have a lower coefficient of thermal expansion (CTE) than the metal matrix alone. Instead of diamond, the particles may be copper particles, which therefore have a close CTE to the electrodeposited matrix. This may lower stresses due to the compliance of porous Cu.

In a liquid or phase change cooling system, the seals and manifolds may be electroplated for coolant or refrigerant leakage reduction. The electroplated layer may provide a barrier to slow refrigerant leakage from a system.

A thermally dissipative substrate may encompass both an integrated circuit or its packaging, and auxiliary components that bond to the substrate and contribute to thermal stress on the chip, e.g., manifolds bonded to chips and seals like O-rings/gaskets/adhesives that secure the manifold to the chip or lid.

A spatially-selective deposition refers to the controlled formation of a structure that encompasses both deterministic voids (predefined regions without material deposition) and non-deterministic voids (randomly occurring or self-organized voids). This definition encompasses structures such as fins, where specific regions are deliberately left uncoated or unfilled, as well as porous structures formed by inclusions that are bonded through electrochemical deposition, resulting in interconnected voids.

A strike layer as denoted herein encompasses both an electrically conductive layer added to the substrate to make it conductive and prepare for subsequent deposition, and a substrate that is already sufficiently conductive and compatible with subsequent deposition.

A mask as denoted herein encompasses both a physical mask or a software defined mask that controls where ions are deposited on the working electrode. The physical mask impedes ion transport to the working electrode, with the physical mask positioned proximal or near to the working electrode or counterelectrode, or somewhere between the two. The software defined mask can be a counterelectrode that has addressable pixels, or a physical counter electrode that moves over the buildplate in a pattern that builds up the desired object.

Electroplating provides a method to make parts with solid metal or metal with particle inclusions, without thermal excursions and uses a process that is already done at scale.

The technology involves adding particles to electroplating bath and then electroplating them together. This electrosintering can create porous structures or filled in structures where metal fills around the inclusions. For instance, copper powder can be electroplated with copper particles to make a porous copper wick. Alternatively, metal coated diamond inclusions can be deposited and printed around using the same method with variable porosity.

This technique can be used in additive manufacturing by combining with a template (possibly sacrificial by removal later) or by combining with pixel or stencil based selective electroplating.

Electroplating inclusions in metals with intentional interconnected porosity are desired for many applications. As electronic AI chips, processors, power and RF electronics continue to higher power and compactness. Advanced microprocessors and electronic components generate substantial heat, necessitating the development of high-performance solutions capable of dissipating heat quickly and efficiently (wicks, thermal interface materials/bonding).

The present technology provides a method for fabricating porous structures made from inclusions. For instance, copper porous materials, copper-diamond porous composites with enhanced thermal properties, and copper coated with other materials to prevent oxidation or modify wetting. This technology enables porous structures to be made by electroplating. It is also adaptable to additive manufacturing by methods including electroplating with specific counter electrode arrays (e.g., Fabric8Labs), templates (including sacrificial), or templated counter electrodes.

This technology provides an electrochemical method for fabricating copper-diamond porous composites with enhanced thermal properties, tailored to meet the demands of advanced thermal management in electronics. The fabrication process begins with a non-metallic or metallic substrate, such as a 3D-printed polymer, which is rendered conductive through either electroless plating or the application of conductive coating (e.g., graphite or silver paint), physical or chemical vapor deposition. Once the substrate achieves conductivity, copper can be electroplated directly onto the pre-treated surface. In the case of metallic substrates, electroplating may occur using donor plates (e.g., copper, iron, or nickel) or an electroless coating non-metallic substrate.

To create a composite with high thermal conductivity and customizable porosity, the method involves embedding powder like copper powder and optionally diamond particles, which are pre-coated with a conductive layer (such as copper or metal carbide). These particles are introduced into the electroplating bath and incorporated layer by layer, resulting in a uniform distribution of powder throughout the composite. This layered electroplating approach significantly enhances the bonding between the copper and diamond particles within the copper matrix, ensuring improved mechanical integrity and thermal performance of the composite. Although in alternate embodiments, a continuous deposition of powder and metal electrodeposited phase can be used.

The technology allows for flexibility in forming diverse geometric shapes directly onto non-metallic substrates, accommodating the need for customized configurations in electronic devices. This method not only improves the structural and thermal properties of copper-diamond composites but also offers versatility in creating heat-dissipating components.

This process can be combined with many types of additive manufacturing. For instance, it can be combined with a sacrificial mold. It can also be combined with electrochemical additive methods that electrodeposit in a pixel-addressable manner. For instance, the electrodeposition solution can have an agitator and dispersed particles (possibly aided by a surfactant). The compatibility with this process would require the powder to be small enough to pass through the typical counter electrode workpiece gap. It can also work with templates that are filled with by electroplating. This template to be electroplated onto can be made by 3d printing methods (vat polymerization, fused deposition modeling, stencils, stamps). The sedimented powder in a layer-by-layer method can be shaped by method including stamps or stencils. The powder phase can also be deposited in some implementations as a slurry or paste. The powder phase can also be stenciled in this case

It is an object to provide a structure, comprising: a composite, containing inclusions bonded by a solid material formed by reduction or oxidation of ions in solution; and a strike layer of a substrate, configured to enhance at least one of formation and adhesion of the composite on the strike layer.

The material may be formed by electrochemical deposition by a current flowing through the strike layer. The material may be formed by electroless deposition.

The composite may be formed in a spatially-selective manner as a series of superposed incomplete layers. The composite may be formed in a process without a physical mask, with spatial deposition controlled by a location of a current or catalytic reduction.

The inclusions may comprise solid particles configured to increase the heat dissipation rate and reduce the coefficient of thermal expansion of the composite.

The substrate may comprise a patterned semiconductor material integrated circuit.

The inclusions may comprise at least one of diamond, graphite, carbon nanotubes, graphene, and boron nitride. The inclusions may further comprise an interlayer of a carbide selected from the group consisting of nickel carbide, cobalt carbide, chromium carbide, zirconium carbide, and boron carbide.

The material may be a metal, and the inclusions may comprise metal particles. The deposition process for the material may leave porosity, and preferably interconnected spaces or channels, which may provide wicking capability.

The material may be a metal, and the inclusions may be non-metallic particles coated with an interlayer having an intermediate Debye temperature with respect to the metal and the non-metallic particles. For example, the interlayer may be a metal carbide or intermetallic.

The structure may be configured to have interconnected porosity.

The inclusions principally have a mass average diameter of between 10 and 500 microns in diameter, for example 40 microns.

The structure may comprise a heatsink, and the structure may further comprise a ductile metal layer between the strike layer and the composite.

The strike layer may comprise an adhesion layer selected from the group consisting of Ti, Cr, V, Ni, TiN, Ta, TaN, Mo, TiW.

The composite may be formed in a spatially-selective pattern, e.g., with stress reducing gaps.

The composite may comprise at least one of metallic copper, silver, gold, and aluminum.

The spatially-selective electrochemically bonded composite structure may have an artery-capillary structure.

The structure may further comprise a polymeric manifold system configured to contain a flow of a heat transfer fluid. The polymeric manifold may have a sealed passage for containing a phase change refrigerant. The passage may be coated with a metallized layer formed by electrochemical deposition or electroless deposition, to reduce diffusion of the refrigerant through the wall of the passage. Similarly, the structure may comprise a sealing ring, which can be metallized according to the present technology to reduce permeability to refrigerant. The structure may comprise a seam, and the seam electroplated or electrolessly plated to seal the junction.

It is another object to provide a method of forming a structure on a substrate comprising forming a composite by reduction of ions in solution to a solid matrix surrounding inclusions on a strike layer of a substrate. The solid matrix may be a metal, and the inclusions may comprise solid particles configured to increase a thermal transfer rate and reduce a coefficient of thermal expansion of composite. The solid particles may also be provided to increase wicking. The method may further comprise applying a mask to the substrate, forming the composite with spatial constraints imposed by the mask, and removing the mask after formation of the composite with the spatial constraints. The method may also comprise providing a localized deposition with a small repositionable anode, e.g., an inert conductor, in close proximity to the substrate, which acts as a cathode and accumulates the reduced metal from the electrolyte solution.

The forming of the composite may comprise periodically sedimenting solid particles suspended in the solution, and periodically electroplating the solid matrix with electroplating pulses to surround the sedimented particles with the solid matrix.

It is another object to provide a heat dissipation device having a sealed cooling fluid path, having an internal coating on the sealed cooling fluid path comprising an electrochemically or electroless formed metallic film configured to impede coolant leakage from the sealed cooling fluid path

It is therefore an object to provide a structure, comprising a strike layer deposited on a substrate, having a conductive surface; and a spatially-selective composite structure, containing inclusions bonded to a matrix of an electrochemically bonded composite structure.

The matrix of the electrochemically bonded composite structure may be a metal, and the inclusions may comprise solid particles configured to increase a thermal transfer rate and reduce a coefficient of thermal expansion of the electrochemically bonded composite structure.

The thermally dissipative substrate may comprise a patterned semiconductor material integrated circuit.

The inclusions may comprise at least one of diamond, carbon nanotubes, graphene, and boron nitride.

The matrix of the electrochemically bonded structure may comprise a metal and the inclusions comprise metal particles.

The matrix of the electrochemically bonded material may comprise a metal and the inclusions may be non-metallic particles coated with an intermetallic composition.

The inclusions may comprise diamond particles coated with a metal carbide. The metal carbide may be formed in situ in a reaction between the diamond and the matrix of the electrochemically bonded composite structure.

The inclusions may principally have a mass average diameter of between 10 and 500 microns in diameter, e.g., 40 μm, between 25-75 μm, between 30-60 μm, etc.

The structure may comprise a heatsink, with a ductile metal layer formed between the strike layer and the electrochemically bonded composite structure.

The strike layer may comprise an adhesion layer selected from the group consisting of Ti, Cr, and V.

The spatially-selective electroplated matrix of the electrochemically bonded composite structure may comprise islands with stress reducing gaps.

The matrix of the electrochemically bonded composite structure may comprise at least one of metallic copper, silver, gold, and aluminum.

The spatially-selective electrochemically bonded composite structure may have an artery-capillary structure.

The structure may further comprise a polymeric manifold system configured to contain a flow of a liquid heat transfer fluid or a phase-change heat transfer fluid.

It is another object to provide a method of forming a structure on a substrate, comprising: depositing a strike layer on the substrate having a conductive surface; and forming a spatially-selective pattern by electroplating an electrochemically bonded composite structure, containing inclusions bonded to a matrix of the electrochemically bonded composite structure.

The matrix of the electrochemically bonded composite structure may be a metal, and the inclusions may comprise solid particles configured to increase a thermal transfer rate and reduce a coefficient of thermal expansion of the electrochemically bonded composite structure.

The method may further comprise forming an intermetallic composition on a surface of the inclusions during the electroplating.

The method may further comprise depositing sacrificial elements, and removing the sacrificial elements after formation of the spatially-selective electrochemically bonded composite structure.

The electroplating of the spatially-selective pattern may comprise periodically sedimenting solid particles suspended in a solution and periodically generating electroplating pulses to electrochemically deposit the matrix around the sedimented particles.

It is a further object to provide an electrochemically produced electrochemically bonded copper structure that incorporates high thermal conductivity inclusions of copper metal or diamond coated with metal-carbide.

It is also an object to provide a cooling structure, comprising a metallized strike layer deposited on a thermally dissipative substrate; and a spatially-selective electroplated metal structure, containing solid inclusions configured to reduce a coefficient of thermal expansion of the metal structure.

It is also an object to provide a method of forming a cooling structure on a substrate, comprising depositing a metallized strike layer on a surface of the substrate; and forming a spatially-selective pattern metal structure containing solid inclusions by electrochemical deposition of the metal surrounding the solid inclusions, a presence of the solid inclusions reducing a coefficient of thermal expansion and increasing a thermal conductivity of the metal structure.

It is a further object to provide a non-transitory computer-readable medium storing instructions for controlling an automated control to form a spatially-selective pattern metal structure containing solid inclusions by electrochemical deposition of the metal surrounding the solid inclusions on a substrate. A non-transitory computer-readable medium may also include instructions for controlling automated machines to perform other aspects of the process.

The thermally dissipative substrate may comprise a patterned semiconductor material integrated circuit.

The inclusions may be further configured to increase a thermal conductivity of the metal structure. In some cases, the inclusions are intended to match a CTE, which may require the inclusions to have a greater CTE than the surrounding matrix.

The inclusions may comprise at least one of diamond, carbon nanotubes, graphene, and boron nitride.

The inclusions may be coated with an intermetallic composition, in situ during processing, or ex situ before the electrochemical deposition. The inclusions comprise diamond coated with a metal carbide. The metal carbide may be formed in situ in a reaction between the diamond and a metal of the metal structure.

The inclusions may have a diameter less than 10μ, 8μ, 6μ, 5μ, 4μ, 3μ, 2μ, 1μ, 900 nm, 800 nm, 700 nm, 600 nm, 500 nm. 400 nm, 300 nm, 200 nm, 100 nm, 80 nm, 60 nm, 50 nm, 40 nm, 25 nm, or 10 nm in diameter. For example, the particles may have a distribution with a median of 1μ, and a 95% distribution from 500 nm to 1.5μ. Small particles, with their relatively larger interface area, may have reduced thermal transfer, and therefore may be avoided. Heterogeneous particle sizes may pack better, with greater probability of particle-to-particle or particle-to-metal carbide-to-particle interfaces, increasing thermal transfer. Typically, the particles may be of a single material, though the technology is not so limited.

The cooling structure may further comprise a ductile metal layer between the strike layer and the metal structure.

The strike layer may comprises an adhesion layer selected from the group consisting of Ti, Cr, and V.

The spatially-selective electroplated metal structure may comprise islands with stress reducing gaps. The gaps, especially if not intended or configured as solid-gas thermal transfer surfaces, may be filled with a thermal transfer liquid, ductile solid, or flowable powder (such as the particles which are included within the metal matrix).

The spatially-selective electroplated metal structure may comprise at least one of copper, silver, gold, and aluminum, and may be a suitable alloy. The alloy may include at least one component that forms intermetallic compositions with the inclusions under electrochemical deposition process conditions.

The strike layer may be formed by at least one of electroless deposition, physical vapor deposition, cold spray deposition, and laser powder bed fusion.

The metallized strike layer may be formed by spraying. In some embodiments, this can include graphene or graphite flakes aerosol sprayed over a substrate.

The metallized strike layer may be formed of a conductive graphitic coating with or without an adhesive binder.

The metallized strike layer may be formed of a conductive metal phase combined with an adhesive (e.g., silver epoxy).

The spatially-selective electroplated metal structure may be configured as an artery-capillary structure.

The spatially-selective electroplated metal structure may comprise a continuous base layer and at least one additional layer that comprises selectively deposited regions having increased height over the base layer.

The cooling structure may further comprise a polymeric manifold system configured to contain a flow of a liquid heat transfer fluid or a phase-change heat transfer fluid.

The method may further comprise forming an intermetallic composition on a surface of the inclusions during the electrochemical deposition of the metal surrounding the solid inclusions.

The method may further comprise depositing a ductile metal layer between the strike layer and the spatially-selective pattern metal structure.

The method may further comprise depositing sacrificial elements, and removing the sacrificial elements after formation of the spatially-selective electrochemically deposited metal structure.

It is also an object to provide a cooling structure for a semiconductor device, comprising: a metallized strike layer deposited on the semiconductor device; and a spatially-selective electroplated metal structure. The electroplated metal structure may contain solid inclusions configured to reduce a coefficient of thermal expansion of the metal structure.

The solid inclusions may be formed by suspending or providing the solid inclusion material in the electrolyte, and slowing the electroplated metal structure to form around particles of the solid inclusion material.

It is also an object to provide a method of forming a cooling structure on a semiconductor device, comprising: depositing a metallized strike layer the semiconductor device; and forming a metal structure containing solid inclusions by electrochemical deposition metal surrounding the solid inclusions in a bulk spatially-selective pattern, the solid inclusions having a lower coefficient of thermal expansion than a metal component of the metal structure, such that the heterogeneous structure has a lower coefficient of thermal expansion than a metal component of the metal structure.

It is a further object to provide a metal cooling structure built onto the semiconductor substrate, comprising: at least one adhesion layer formed on the semiconductor substrate; a spatially selective electrochemically formed structure comprising solid inclusions, which are preferably non-electrochemically formed; and at least one ductile metal interlayer between the at least one adhesion layer and the spatially selective electrochemically formed structure.

The inclusions may be further configured to increase a thermal conductivity of the metal structure. The inclusions may comprise diamond. The inclusions may comprise a material consisting essentially of sp² hybridized atoms, e.g., sp² hybridized carbon atoms. The inclusions may comprise a crystalline material consisting essentially of sp³ hybridized atoms. The inclusions may be coated with an intermetallic composition or the metal of the metal structure or an alloy. The inclusions may comprise diamond coated with a metal carbide. The inclusions may be micron-sized. The inclusions may be nanoscale.

The cooling structure may further comprise a ductile metal layer between the strike layer and the metal structure. The ductile metal may comprise indium, tin silver alloy (SnAg), or tin-silver-copper alloy (SnAgCu).

The strike layer may comprise an adhesion layer selected from the group consisting of titanium, chromium, and vanadium.

The spatially-selective electroplated metal structure may comprise islands with stress reducing gaps. The spatially-selective electroplated metal structure may comprise metallic copper, metallic copper alloy, metallic silver, a metallic silver alloy, metallic aluminum, or a metallic aluminum alloy.

The inclusions may comprise diamonds, and a surface of the diamonds may be reacted with metal of the spatially-selective electroplated metal structure to form a metal carbide.

The inclusions may comprise boron nitride.

The cooling structure may further comprise a low melting interlayer between the strike layer and the spatially-selective electroplated metal structure. The strike layer may be formed by electroless deposition, physical vapor deposition, cold spray deposition, or laser powder bed fusion. The strike layer may be heat processed.

The spatially-selective electroplated metal structure may have a deterministic porosity or inclusions, non-deterministic porosity or inclusions, or an artery-capillary structure.

The spatially-selective electroplated metal structure may comprise a continuous base layer and at least one additional layer comprises selectively deposited regions having increased height over the base layer.

The semiconductor device may be releasably captured in a holder, further comprising a polymeric manifold system.

The polymeric manifold system may be formed by fused deposition modeling. The polymeric manifold system may be a UV-cured polymer, e.g., formed by UV curing a polymer, typically in an additive manufacturing process. The polymeric manifold system may also be formed of a polymer that is compatible with a phase change fluorinated refrigerant. The polymeric manifold system may also be formed of a polymer containing a 2D material adapted to slow diffusion of the phase change fluorinated refrigerant.

The 2D material may comprise graphene. The 2D material may comprise boron nitride.

The solid inclusions may have a homogeneous or heterogeneous distribution within a bulk of the spatially-selective electrochemically deposited metal structure.

The method may further comprise depositing sacrificial elements, and removing the sacrificial elements after formation of the spatially-selective electrochemically deposited metal structure. The sacrificial elements may be deposited adjacent to the spatially-selective electrochemically deposited metal structure. The removed sacrificial elements may correspond to boiling nucleation sites or flow channels.

The spatially-selective electrochemically deposited metal structure may be formed over a continuous base layer, and at least one additional layer formed comprising selectively deposited regions having increased height over the base layer.

The solid inclusions may be suspended in a surrounding liquid electrolyte medium during electrochemical deposition.

The at least one ductile metal interlayer may be formed of a metal selected from the group consisting of In, Sn, SnAg, SnAgCu, a solder, a metal alloy comprising at least one of In, Sn, At, Pb, Ag, Cu, Au, Bi, Zn, and Al, or at least one of Ti, Cr, and V.

The solid inclusions may have micron or nanometer scale.

The solid inclusions may have a lower coefficient of thermal expansion and/or a higher heat transfer coefficient than a matrix of the spatially selective electrochemically formed structure.

The spatially selective electrochemically formed structure may comprise at least one of copper, silver, and gold. The at least one of copper, silver, and gold may be alloyed with tungsten to achieve a reduction in coefficient of thermal expansion of the spatially selective electrochemically formed structure.

The spatially selective electrochemically formed structure may be configured having a plurality of islands with stress reducing gaps.

The at least one adhesion layer may comprise a metallized strike layer. The metallized strike layer may form an intermetallic bond with a matrix material of the spatially selective electrochemically formed structure.

The spatially selective electrochemically formed structure may have at least one surface configured as a heat transfer surface. The heat transfer surface may be an external surface or a bounded internal surface.

The solid inclusions may be of a concentration and material such that a coefficient of thermal expansion of the spatially selective electrochemically formed structure with the solid inclusions matches a coefficient of thermal expansion of the semiconductor substrate.

The metal cooling structure may further comprise a manifold or manifold connection.

The metal cooling structure may further comprise an electrical connection to the spatially selective electrochemically formed structure, configured to carry a current. The current may power an electrical circuit formed on the semiconductor substrate. The metal cooling structure may have selectively formed conductive traces isolated by insulating layers or air. The selectively formed conductive traces may form a circuit, and be associated with one or more sensors, one or more output devices or antennas, and/or one or more analog or digital processing circuits.

The spatially selective electrochemically formed structure, especially for embodiments that have two-phase cooling.

The porosity can be induced by modulating the current rates and the deposition rates.

The porosity can be made by including copper powder and electrodepositing to bond the powders. Porosity benefits two-phase cooling by providing wicking by capillary pressure, aiding evaporation/boiling in two-phase cooling applications. In many embodiments it will also delay dryout based two-phase cooling failure. The porosity also lowers thermal stress as the wick imparts less stress to the substrate than a solid part.

In some embodiments, the metal structure whether can have a final electroplating or electroless plating with a metal that provides chemical and corrosion-resistance. For instance, a nickel or chromium finish can provide chemical and corrosion resistance over a porous copper or diamond-copper composite.

The spatially selective electrochemically formed structure may be configured to dissipate heat from the powered electrical circuit. The current may be a radio frequency communication signal. The spatially selective electrochemically formed structure may comprise an antenna.

It is a further object to provide a heat removal device comprising: metal features formed by electrochemical methods selectively onto a surface of a chip lid of a packaged electronic device; and an additively manufactured fluid manifold base thermally connected to the metal features. The metal features may comprise copper, silver, and/or gold.

The metal features may be configured to communicate an electrical supply current to the packaged electronic device. The metal features may be configured to act as a radio frequency antenna, to communicate as a radio frequency signal to an antenna, or to act as a heatsink.

The metal features may have solid inclusions of high thermal conductivity material, or of low coefficient of thermal expansion material.

The metal features may have diamond microparticle or nanoparticle inclusions.

Another object provides an electrochemically additively produced structure that incorporates high thermal conductivity inclusions of diamond coated with metal-carbide.

A still further object provides an electrochemically additively produced metal structure that incorporates high thermal conductivity inclusions of diamond where the metal reacts to form a metal carbide on diamond.

An object also provides an electrochemically additively produced metal structure that incorporates high thermal conductivity inclusions of boron nitride.

Another object provides an electrochemically additively produced metal structure comprising a low melting point interlayer interface with a substrate.

A further object provides an electrochemically additively produced metal structure having a configuration defining voids, further comprising an unperforated bonding base layer on a substrate. The unperforated bonding base layer may be a striking layer formed by electroless deposition. The unperforated bonding base layer may be a striking layer formed by physical vapor deposition, cold spray, or laser powder bed fusion.

The unperforated bonding base layer may be a striking layer is processed by a heating step.

Porosity can be introduced with a sacrificial additive to the electroplating.

Another object provides an electrochemically additively produced metal structure having a configuration defining voids formed by removal of a sacrificial material. The voids may have a random or predetermined distribution within the metal structure, and may assume an artery-capillary structure or wick.

A further object provides an electrochemically additively produced metal structure having an entire first layer is added over the heat dissipating area, and at least one subsequent layer that incorporates selective locations of increased height.

A still further object provides a method for packaging an electronic device, comprising releasably capturing the electronic device in a holder on a planar additive manufacturing build surface, with an exposed surface on the electronic device parallel to the plane of the additive manufacturing build surface.

Another object provides a method for thermally packaging an electronic device, comprising: releasably capturing the electronic device in a holder; and building a polymeric manifold system on the electronic device configured to guide a flow of a heat transfer medium.

The polymeric manifold system may be fabricated by fused deposition modeling, or UV-curing.

The polymeric manifold system may comprise a thermoset polymer.

The method may further comprise cooling the electronic device with a non-aqueous liquid, wherein the polymer does not absorb non-aqueous liquid. The non-aqueous liquid may comprise a phase change liquid coolant, e.g., a phase change liquid coolant comprising carbon-fluorine bonds.

This invention also embodies a means to improve the sealing of heat transfer systems, particularly those utilizing polymer components in fluid-cooled electronic devices. The invention provides a method to enhance the integrity of seals within these systems by applying a metallic coating over traditional sealing mechanisms such as adhesives, gaskets, and o-rings. Additionally, it introduces an electrochemical deposition process that reduces coolant leakage paths while maintaining serviceability.

Existing heat transfer systems often rely on polymer-based manifolds and seals, which are prone to coolant permeation, leakage, and erosion over time. Conventional sealing methods such as adhesives and gaskets may degrade due to thermal cycling, pressure fluctuations, or chemical interactions with the coolant. Furthermore, polymer manifolds with small impingement jets are particularly susceptible to erosion, reducing system efficiency and longevity.

Embodiments of this invention addresses leakage issues by introducing a thin metallic coating applied via electrochemical deposition or electroless plating, thereby improving sealing performance, durability, and resistance to erosion while still allowing for component disassembly and servicing.

In some embodiments of this sealing aspect of the invention, the invention provides a multi-step sealing process applicable to various connection points in a sealed heat transfer system including: manifold-to-chip connections, manifold-to-stiffener (package chip's stiffener) interfaces, manifold-to-printed circuit board (PCB) connections, port connections into the manifold, coolant hose-to-plenum interfaces, internal polymer component sealing to reduce coolant permeation. The primary sealing mechanism involves a thin metallic layer (1-100 s of microns thick) applied over traditional sealing elements (e.g., o-rings, adhesives, or gaskets). This metallic layer fills exposed crevices and enhances the sealing properties by reducing permeability. Additionally, electrochemical deposition further bonds components together, reducing leakage paths without preventing disassembly when needed.

In these leakage reduction aspects of the invention, the heat removal device can be assembled and then coated while in place. This confers an advantage over coating each element separately, as the gaps between elements can have leakage paths reduced.

One embodiment of the coolant sealing embodiment of this invention has a process that can consists of a cleaning step, pre-treatment of polymer components with a sensitizer or activator (not always required, especially if polymer has catalyst already present), electroless plating of a thin metal layer onto the sealing materials. The liquids for sensitization, activation, and electrolessplating can be introduced into the system by way of pumping through the fluid ports.

In some embodiments of this sealing aspect of the invention, metallic catalysts for deposition may be pre-applied to elastomeric O-rings or polymer manifolds during manufacturing.

In some embodiments of this sealing aspect, a conductive strike layer can be applied as a liquid through dipping, flow of conductive particles in a fluid through the ports that deposit on the surface, or painting. The paint can include conductive metallic (like Ag nanoparticles) or non-metallic particles (like graphene, graphite)

The embodiments of this invention relating to sealing of coolant and erosion resistance can benefit from metallizing with Ni, Cr, alloys (Ni—P, Ni—B, Ni—W). The deposition can be via electroless plating or electrodeposition. In-situ metal coating can be done by providing the reagents through the fluidic ports for coolant.

Some embodiments of this invention relate to a polymeric and elastomeric materials that reduce coolant diffusivity through them by way of a 2D material added to the material to lower diffusivity rates. Efforts to minimize the leakage of hydrocarbon and fluorocarbon must be taken owing to their environmental impacts (global warming potential, ozone depletion potential, and long lifetimes in the atmosphere). The polymeric manifold system or adhesives or gaskets or O-rings may comprise of a 2D material additive which slows diffusion of a coolant in the polymer. The 2D material may comprise boron nitride or graphene, which are impermeable to large molecules like hydrocarbons and fluorocarbons used in two-phase cooling. These 2D materials can be mixed in the polymer or elastomer. The coolant diffusing through the polymer will have to diffuse around all of these 2D materials, effectively increasing the tortuosity of the coolant diffusion path through the polymer or elastomer, and reducing leakage rates by a significant amount.

It is another object to provide a packaged electronic device comprising: a lid of a packaged electronic device having a surface, and additively formed metal features deposited over the surface.

Another object provides a packaged electronic device comprising: an electrochemically formed metal structure having a surface area at least three times greater than a planar area; and an additively manufactured manifold configured to direct fluid to the structure.

A further object provides a method of producing a heat dissipating structure on an electronic package, comprising: depositing an additively manufactured polymer template; electrodepositing metal adjacent to the polymer template; and removing the polymer template after electrodeposition of the metal.

A still further object provides a method of electrochemically depositing a structure onto an electronic package, comprising: providing a templated counter-electrode; and electrodepositing a metal structure in a patten corresponding to the templated counter-electrode.

An object also provides a metal heat removal device made directly on a semiconductor substrate, comprising: a metallized strike layer formed on the semiconductor substrate; and a spatially selective electroplated structure over the metallized strike layer.

It is another object to provide a metal heat removal device formed directly on a packaged electronic board, comprising: a separable layer formed on the packaged electronic board; a metallized strike layer formed on the separable layer; and an electrodeposited metal layer formed on the metallized strike layer configured to bridge a thermal gap between the packaged electronic board and an adjacent structure.

It is a further object to provide a method of bridging a thermal gap between two structures, comprising: additively manufacturing a positive mold; plating a metal layer on the positive mold; coating the plated metal layer in a thermal bridging material; and releasing the metal layer from the mold. The method may further comprise electrically isolating at least a portion of the metal layer; and interposing the metal layer between the two structures to be thermally coupled.

### BRIEF DESCRIPTION OF THE DRAWINGS

FIG. 1 shows a schematic representation of aspects of the invention.

FIG. 2 shows a schematic illustrating elements of the invention.

FIG. 3A shows a schematic illustrating elements of the invention, which embodies electrochemical methods of making structures.

FIG. 3B shows a schematic illustrating elements of the invention, which embodies postprocessing of the structures.

FIG. 4 shows an abrading lid/chip surface, and subsequent printing onto it.

FIG. 5 shows mounting multiple lids or chips in one build plate.

FIG. 6 shows a directly printed heatsink in a single-phase flow setup used to cool microprocessor.

FIG. 7 shows a printed polymeric manifold directly on metal cooling features of a chip or chip underlying substrate.

FIG. 8 shows a printed polymeric manifold directly on metal cooling features of lid.

FIG. 9A shows a graph of thermal boundary temperature versus Debye temperature for various coatings on diamond.

FIG. 9B shows a graph of effective thermal conductivity of diamond metal composite versus diamond volume fraction.

FIG. 10A shows polymeric substrate, simulating part of an O-ring or polymeric manifold to be reinforced.

FIG. 10B shows a polymeric substrate coated with sprayed graphite strike.

FIG. 10C shows a polymeric substrate coated with electroplated copper.

FIG. 10D shows silicon substrate, simulating a silicon chip, masked with removable tape for spraying graphite strike.

FIG. 10E shows a silicon substrate coated with sprayed graphite strike.

FIG. 10FC shows a silicon substrate coated with electroplated copper.

FIG. 11 shows a schematic representation of the diamond powder preparation step using electroless nickel plating to improve diamond-copper thermal conduction and provide a conductive strike layer to the diamond.

FIG. 12A shows a scanning electron microscopy image of the neat synthetic diamond particles prior to metallization.

FIG. 12B shows a scanning electron microscopy image the synthetic diamond post-electroless Ni deposition.

FIG. 13A shows a scanning electron microscopy image of diamond-Cu composite.

FIG. 13B shows a zoomed-in scanning electron microscopy image of diamond-Cu composite.

FIG. 14A shows a scanning electron microscopy image of neat Cu powder.

FIG. 14B shows a scanning electron microscopy image of Cu powder electroplated with Cu into a porous material.

FIG. 15 shows a porous material templated with a removable mask.

### DETAILED DESCRIPTION OF THE PREFERRED EMBODIMENTS

### Example 1

### Integrated Circuit Lid or Chip Surface

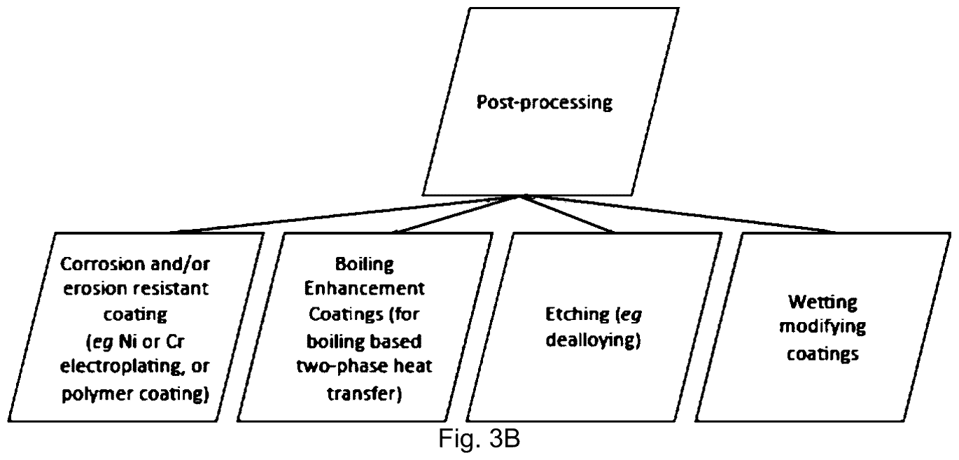

FIG. 4 shows an abrading lid/chip surface, and subsequent printing onto it.

Leveling can be achieved by mounting multiple devices in a build plate cassette that can be made sufficiently level. A moldable material can be used to achieve this. For instance, the part or parts to be printed on can be upside down on sufficiently flat table. The top layer of a build plate with cutouts for the devices can be placed over these devices. Then a curable material (e.g. resin, wax putty) that can later be released (by mechanical, thermal, chemical, or optical methods) can bond the device or devices level. Further leveling can be handled by abrading or machining the lids or devices in a fixture to planarize them. This leveling is important for heterogeneously integrated chip packages that have multiple chips that are non-planar owing to the residual stresses from packaging processing. These chips could even be different heights. Polishing to level out warpage non-planarities could also be necessary for very large chip packages (e.g., 8.5″×8.5″ Cerebras Wafer Scale Engine). Alternative methods to secure chips could involve mounting with alternate means, like suction, tape, retention frame, silicones, and dissolvable polymers. The devices could also be leveled with screws that adjust the tilt in the build plate cassette. Then this fixture can be secured into the additive manufacturing printer.

For implementations on lids of chips, in some implementations the lid can be printed post installation onto the chip package, while in other implementations the lid can be printed prior to lid mounting. Printing prior to mounting lid is beneficial at highest scale production, but if chips are already lidded, and done at low to moderate scales, there may be efficiencies in leaving the lid attached to the chip.

In implementations onto chips directly, in most implementations the chip will be processed for heat removal surface area enhancements and/or boiling enhancements post-packaging. However, in some implementations, it may be beneficial to print these structures prior to packaging or at an intermediate stage of packaging.

Printing cooling structures, or similar externally protruding structures like antennas or power connection leads onto a semiconductor device or lid, requires the surface be electrically conductive and clean. An electrically conductive strike layer can be added on a non-conductive or low-conductivity layer by electroless deposition, physical vapor deposition (e.g., sputtering, evaporation, or plasma enhanced sputtering), chemical vapor deposition (e.g., atomic layer deposition), thermally applied layers (laser powder fusion), cold spray, ultrasonic bonding, among others. This initial layer of this strike must form a strong bond to the electronic substrate, otherwise mechanical stresses will lead to mechanical failure (lifting off of metal from substrate). Metals that form an intermetallic bond with the semiconductor can provide a strong bond. For silicon, metals that form a metal silicide, like titanium and chromium, will be best for an initial strike layer (e.g., Group IV, V, VI for silicon and many semiconductor substrates). Generally, adhesion to many electronic substrates can be made for silicon by the formation of a metal silicide. This layer can be quite thin, <10 nm, followed by other metals that bond well to the initial layer. Regarding the bonding of metals to semiconductors by intermetallics, see U.S. Pat. No. 11,167,375 and US 2020/0047288. For electroplating initial strike layer, the conductive layer should be on the order of tens of microns thick.

If the layer exposed is already sufficiently conductive, but has been left exposed to air, an oxide and/or hydrocarbon film layer then forms could impede electroplating. Therefore, a cleaning step is preferred. Cleaning can include an abrasive to mechanically remove oxide, chemical agent(s) to remove oxide (e.g., reducing agent), and solvents and/or surfactants to remove hydrocarbons.

Bonding to the semiconductor or ceramic substrates can be achieved by active elements such as Ti, Zr, V, Nv, Hf, Ta, Mo, Cr, and W. The active alloy may form intermetallic compounds such as silicides on Si and SiC, and carbides on graphite, and diamond, or amorphized mixtures of the substrate and reactive metal elements on the surface of many dissimilar substrates. The deposition can be via electroless plating, electroplating, physical vapor deposition, chemical vapor deposition, low melting point solders mixed with reactive elements or liquid metals. After depositing of the adhesion layer and strike layer (as necessary), high conductivity materials such Cu or Ag, among other metals and alloys can be electroplated, to form high conductivity structures onto the low-melt interlayer alloy. See, (126, 127, 29, 117, 155)

The electrochemical deposition process (modified by the presence of particles which form the inclusions) may be conducted generally according to the techniques disclosed in: (153, 154, 158, 159, 180).

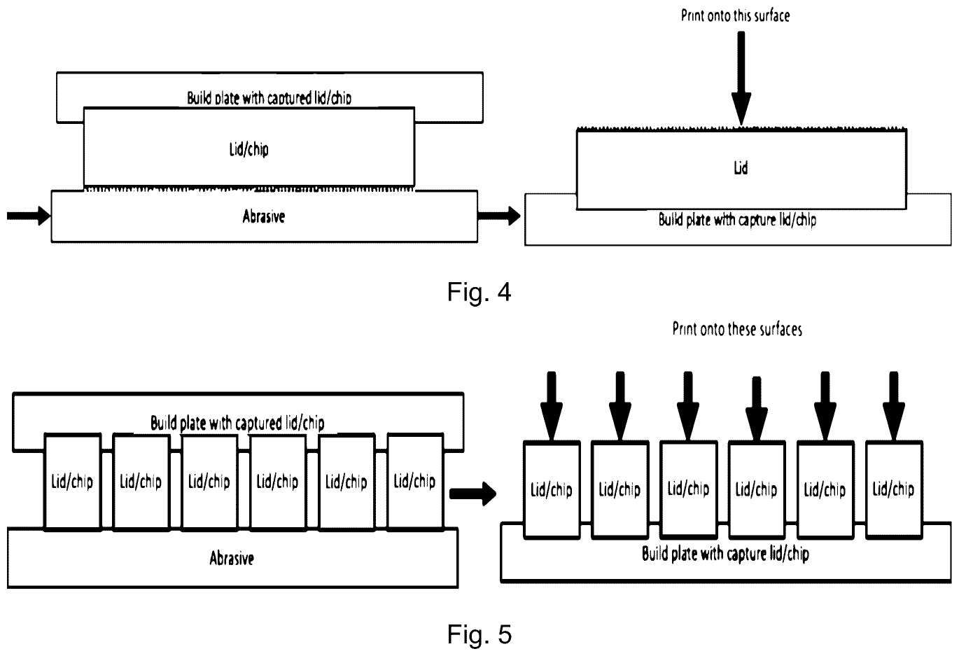

FIG. 5 shows mounting multiple lids or chips in one build plate.

Electrical connection can be made to the structure by means of a temporary connection like a solder drop, or mechanical connector (e.g., alligator clip), or through a structure formed on or in the substrate. Care can be taken to prevent the current from flowing into any active devices in a way that would damage it or deposit material where it would be undesired. This unwanted deposition can be avoided by making connection to device at ground potential and having the buildplate at the same potential. This processing can be on packaged or unpackaged devices, e.g., silicon chip after packaging, i.e., connection to another printed wiring board or interposer, silicon chip before packaging to printed wiring board, or lidded chip, or just the lid by itself.

The silicon device electrochemically added to can be the silicon substrate with e.g., an integrated circuit with transistors formed, or a purely thermal silicon layer that is subsequently bonded to the transistor-containing silicon device by well known methods to bond silicon-to-silicon. Silicon is used as an example, but in alternate embodiments applies to other substrates, including SiC, GaN, GaAs, GaSb, Ge, SiGe, InP, InSb, Lithium Niobate, Lithium Tantalate, Tellurium Oxide, Sn-doped β-Ga₂O₃, AlN, Fused Silica, Quartz, Glass, Diamond, Sapphire, etc., which have applications in different realms (e.g., power electronics or RF electronics). Indeed, the substrate need not be an electronic substrate, and rather may be part of a mechanical or microelectromechanical system (MEMS), thermodynamic, or other system.

The electroplating solution may be detrimental to certain elements of the device, especially over long-term. Residue of the electroplating bath should be removed by rinsing, and/or ion sequestration. Sealing of sensitive elements to minimize electroplating bath exposure can be achieved by a barrier (e.g., tape, polymer, oxide, underfill, glue), which can be included in the build plate cassette mounting method.

The build plate cassette fixturing can use a tight tolerance fit, and print on an already packaged device. Alternatively, the part can be retained via suction or mechanical fixturing mechanism. Tape or gaskets can be used to seal electroplating liquid from infiltrating into areas where it would be detrimental.

The actual electroplating build volume may be smaller than the build plate cassette, so the printing process proceeds over a smaller region of the build plate and is then re-positioned periodically.

The printed parts can be used as is. However, traces of metal and electroplating solution may lead to fouling of pumps, or narrow channels, so the part may benefit from post-processing to clean. The postprocessing can include a rinse, ultrasonic bath, compressed air, media blasting, immersion of the component in a dielectric liquid bath, chemical processing. Vacuuming and pressurized air and/or fluids can help clean any residue from the print. Removal of any sacrificial material may also be required, by means including chemical, thermal (melting or heat release adhesive/polymer), optical power deposition.

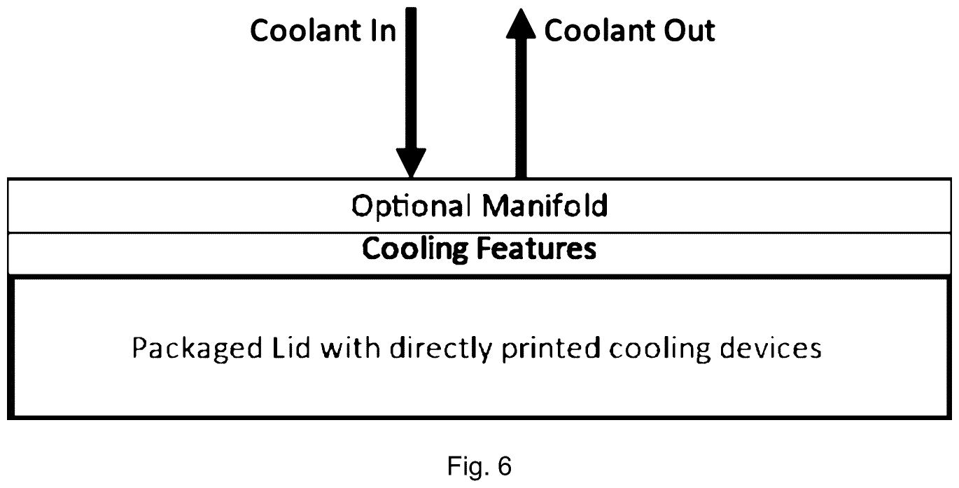

FIG. 6 shows a directly printed heatsink in a single-phase flow setup used to cool microprocessor.

The design of the heatsink on the lid can take various forms, including fractal-like, thin film of variable porosity, or wick and lattice, or lattice with porous wick exterior. The designs are dependent on the method of cooling (forced convection single-phase or two-phase, pool boiling, air cooled, etc.).

The porosity of wicks can be tuned by changing the processing and additives. In particular, it can be tuned by the deposition rate (voltage/currents), as well as electroplating additives in the form of particles and chemicals. This can include incorporating non-interacting or sacrificial particles or components, that can be later removed. Additional electroplating solution reagents can be added (microlevelers, accelerators, suppressors) to improve print quality. Electroplating a metal that can be dealloyed, as explored in the non-additive literature (Erlebacher et al, McCue et al.), leaving porosity is also an embodiment.

Smaller particles will have high capillary driving pressure but also lower permeability (resulting in higher pressure drops). These are competing effects: smaller particles have bigger driving pressures but also have greater pressure drop for the same flow rate. Secondary effects of thermal conductivity versus particle size and contact area also exist. By printing with varying energy densities, different degrees of porosity can be affected spatially (similar to biporous wicks for heatpipes). By controlling the porosity spatially, regions of high porosity, that act like arteries, can feed progressively narrower capillaries. Different deposition conditions can be used over the part or between layers, to achieve a range of properties.

### Example 2

Bonding onto Mismatched Substrate by Additive Electroplating

Mechanically bonding electronic substrates (Si, SiC, GaN, etc.) to large metal features can be problematic, as the CTE mismatch can damage the silicon. The CTE of Si, SiC, GaN are 2.6× 10⁻⁶, 4.0×10⁻⁶, 5.6×10⁻⁶, versus for Cu of 16.7×10⁻⁶ and Ag, of 19.5×10⁻⁶. This means that especially if large features are printed on the substrate, the wafer will experience dynamic stresses during transient heating and cooling cycles (power on and off cycles of the electronics).

The technology provides a series of options, including 1) depositing an interlayer of a ductile interlayer of sufficient thickness to accommodate thermal stresses, 2) electrodepositing a CTE matched material, and 3) depositing features that are limited to small contact areas over the substrate, over whose length the thermal stress from CTE will not lead to reliability issues (could include a plethora of isolated islands that are bonded to the substrate.

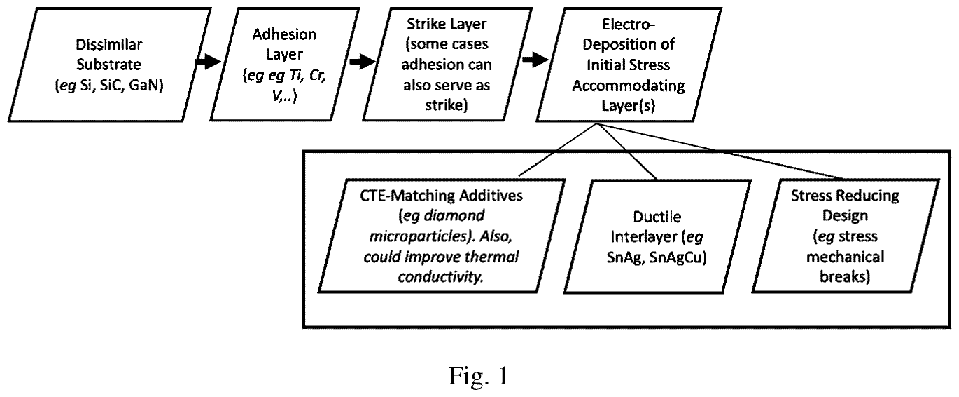

FIG. 1 shows a schematic representation of aspects of the technology.

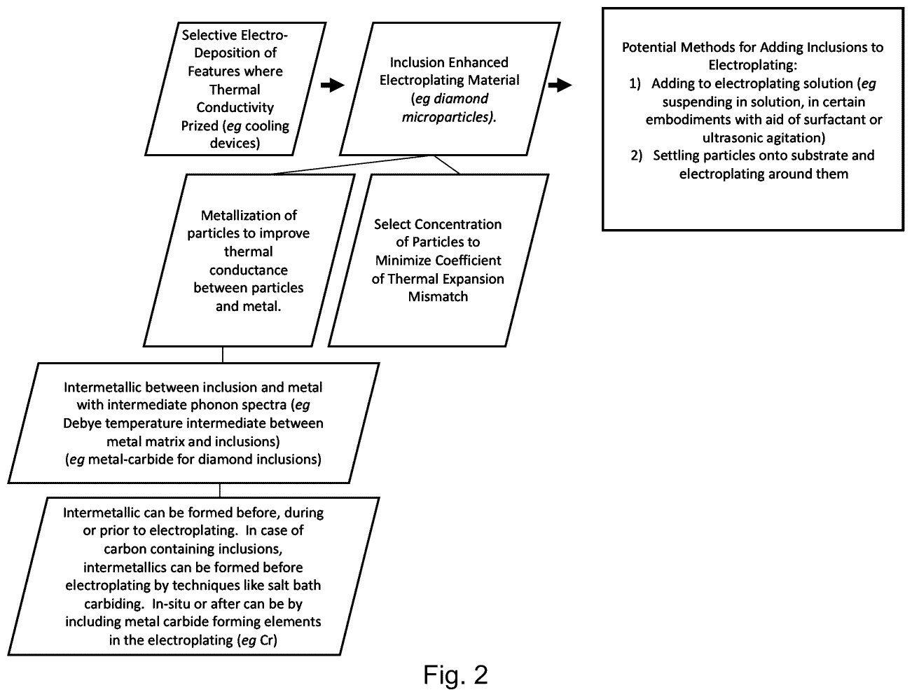

FIG. 2 shows a schematic illustrating elements of the technology.

In one embodiment, a ductile interlayer of sufficient thickness to accommodate thermal stresses is provided on the substrate to be cooled, and has certain advantages in that a high thermal conductivity material like pure Cu or Ag can be subsequently used, however, the larger the lateral dimensions of the stiff subsequently printed solid, the greater the extreme maximum to minimum temperature and the greater the number of stress cycles to be survived, the greater the thickness of the ductile interlayer must be to accommodate the thermal stress and warpage imposed by thermal stresses. The thermal stresses may not be obvious over a single cycle, but gradually accumulate damage to fatigue fail the interlayer. Potential interlayers could include indium, tin, solders including Sn—Ag, Sn—Ag—Cu, among others. It could also potentially include liquid metals, though these may pose reliability issues and would typically not enhance adhesion. These interlayers could be deposited by electroplating or other means. This interlayer can range in thickness from ten to hundreds of microns. Thicknesses to achieve acceptable levels of reliability will be similar in requirements to solder-attach thermal interface materials. (Deppisch et al.) Specific applications require reliability testing with a specific package to confirm the exact thickness, as the ductile metals used for stress accommodation react over time, especially with thermal exposure, to grow intermetallics with the adhesion metallization and subsequent less-ductile high layers. The transition in metal deposited can be done by transitioning the electroplating solution, or within a sacrificial electrode, such as by providing a metal or metal alloy concentration gradient.

A superior solution would be to include particles or alloying elements that minimize the CTE mismatch, as this has the potential for higher thermal conductivity. Addition of low CTE inclusions, especially micro-nano inclusions of diamond, BN, CNT, graphene, may be used to increase thermal transfer and/or reduce CTE. These low CTE inclusions, may also be treated to form a low thermal barrier transition layer, to enhance the thermal conductivity. Precise control of inclusion percentages might be challenging due to settling while in electroplating solution. One possible solution is to provide a particulate feed system to ensure that the particles are in the correct concentration/amount at the accretive surface of the structure during growth.

These CTE reducing inclusions could be hard to suspend in solution, so the manufacturing process may benefit from being deposited in a slurry and then electroplated around for the first few layers. Alternatively, they could be suspended in the solution by using micro to nano particles, with surfactants that aid in the suspension longevity and prevent agglomeration. (146.) The diamond-containing tool literature has a few examples of diamonds being included in metal via electrodeposition. (120, 144, 128, 151.)

Alternative embodiments would use CTE lowering metal alloys, including Cu—W. These alloys enable control of CTE through an alloying element with a high thermal conductivity metal element. (A.L.M.T. Corp.) The downside of this alloying is a reduction in the thermal conductivity, as alloying metals tend to increase electrical resistivity and decrease thermal conductivity. For instance, 96% W, 4% Cu has a CTE of 6.4, and a thermal conductivity of 141 W/m-K, a reduction of ˜65%, but a closer CTE to common semiconductor substrates.

A complementary strategy is the use of “islands” of deposition, that are small enough that thermal stresses are within range tolerable by the rest of the electronic package. These small islands would be small enough to avoid mechanical failure. This could be especially useful over very large chips, like the Cerebras Wafer Scale Engine (8.5″×8.5″). This could be combined with the two aforementioned strategies. Thermal stress will be proportional to the length of the feature, the difference in substrate-metal CTE, and cyclic temperature range. Smaller features therefore lower the stress build-up.

### Example 3

### Thermal Conductivity and Coefficient of Thermal Expansion Modifying Inclusions

The printed heat spreading material should be of high thermal conductivity, as that extends the useful length of a fin. Metals, like copper, silver, and aluminum are of greatest interest. While silver has slightly higher thermal conductivity than copper (˜3-7% depending on processing), its cost differential makes copper of greater commercial interest. High thermal conductivity composites (e.g., metal with diamond) are also of potential interest. Graphene and carbon nanotubes may also be used.

Diamond that has an intermetallic present on its surface, formed ex-situ or in-situ, will have higher interfacial thermal conductance owing to its more gradual phonon matching to the metal matrix (U.S. Prov. App. No. 63/468,228). Inclusions with high thermal conductivity and/or coefficient of thermal expansion adjusting properties (e.g., lower CTE of metal to match substrate) can also be beneficial. To improve the thermal conductivity, an intermediate layer may be formed that can bridge the phonon spectra of the metal to the high thermal conductivity inclusion. For diamond and other carbon materials (e.g., graphene or nanotubes) this would be a metal-carbide bridge.

There has been little work on laser powder bed fusion of metal diamond composites and this prior work has been predominantly focused on mechanical properties, especially for grinding tools. One prior art reference did measure the thermal conductivity of a printed copper-diamond composite and found it its thermal conductivity less than bulk copper (350 W/m-K for the copper-diamond composite versus 400 W/m-K for pure copper). (166) Prior work functionalized the diamond with films of TiC and then TiO₂ (approximately 0.7 μm thick films) to improve wetting; however, such a thick oxide coating posed a considerable thermal resistance. (165)

Diamond is the allotrope of carbon in which the carbon atoms are arranged in the specific type of cubic lattice called diamond cubic, in which each carbon atom has four neighbors covalently bonded to it. Diamond is the hardest naturally occurring material known. Most diamonds are electrical insulators and extremely efficient thermal conductors.

Unlike most electrical insulators, diamond is a good conductor of heat because of the strong covalent bonding and low phonon scattering. Thermal conductivity of natural diamond was measured to be about 2,200 W/(m·K), which is five times more than silver, the most thermally conductive metal. Monocrystalline synthetic diamond enriched to 99.9% of the isotope ¹²C had the highest thermal conductivity of any known solid at room temperature: 3,320 W/(m·K), though reports exist of superior thermal conductivity in both carbon nanotubes and graphene. Because diamond has such high thermal conductance it is already used in semiconductor manufacture to prevent silicon and other semiconducting materials from overheating. At lower temperatures conductivity becomes even better, and reaches 41,000 W/(m·K) at 104 K (¹²C-enriched diamond). (158, 159)

Technologically, the high thermal conductivity of diamond is used for the efficient heat removal in high-end power electronics. Diamond is especially appealing in situations where electrical conductivity of the heat sinking material cannot be tolerated e.g., for the thermal management of high-power radio-frequency (RF) microcoils that are used to produce strong and local RF fields.

Diamond carries heat predominantly through quantized lattice vibrations called phonons. The characteristic phonon frequencies in the diamond are at higher frequencies than phonons in high thermal conductivity metals like copper and aluminum. This means these traditional heat sink metal materials have poor phononic vibrational overlap in their density of states with diamond, so they will have poorer phonon transport into the diamond at the metal-diamond interface. Carbides have higher characteristic phonon frequency owing to their stiffer elastic moduli than metals. This higher elastic modulus stems from the long-range order and the greater energy stored in the bonds, as evidenced by being enthalpically favored over solid solutions of metal and carbon. The Debye temperature (T_{D})), from the Debye approximation to the phonon dispersion, is the temperature at which nearly all the phonon modes are active, and the specific heat approaches the 3Nk_{b} limit, where N is the number of molecules and k_{b} is the Boltzmann constant. The Debye temperature can be related to a Debye frequency, which is the maximum frequency for thermal energy storage according to the simplified Debye model, where h is Planck's constant. The higher the Debye temperature, the higher the characteristic vibrational frequency. The diffuse mismatch model suggests that materials with closer Debye temperatures will have higher interfacial thermal conductances.

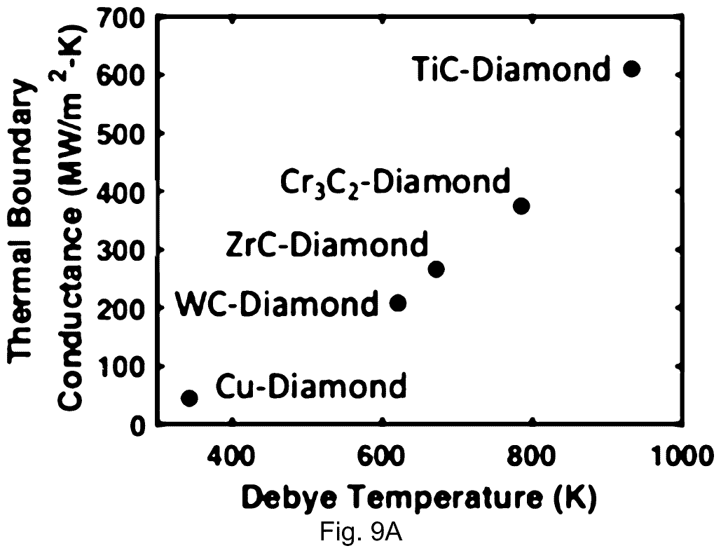

FIG. 9A shows a graph of thermal boundary temperature versus Debye temperature for various coatings on diamond.

FIG. 9B shows a graph of effective thermal conductivity of diamond metal composite versus diamond volume fraction.

Consider an interface of diamond, which has T_{D} of 2,360 K, with pure Cu, pure Ti, or a metal carbide compound (FIGS. 9A and 9B). Stoichiometric carbide compounds have significantly higher Debye temperatures and therefore, predictably higher conductance, as calculated with the diffuse mismatch model. Note by comparison, common solder metals have Debye temperatures less than 200 K, indicating a much lower phonon vibrational spectrum and poor phonon overlap with diamond and semiconductors. The diffuse mismatch calculation predicts that metal-carbide stoichiometric compounds will have a conductance 14 times higher than the conductance of pure Cu at room temperature; hence, additively manufactured diamond metal composites with metal carbide interfaces show promise in reducing electronic operating temperatures.

FIG. 9B shows effective conductivity vs. volume fraction for different thermal boundary conductances using the model of Hasselman and Johnson. Hasselman, D. P. H., and Lloyd F. Johnson. “Effective thermal conductivity of composites with interfacial thermal barrier resistance.” Journal of composite materials 21, no. 6 (1987): 508-515. The upper curve is representative of the good thermal boundary conductance expected between TiC and diamond, while the lower curve is representative of a poor thermal boundary conductance for a non-carbide metal diamond interface. The thermal boundary conductance makes a dramatic difference.

This technology permits the diamond-metal composite matrix to be deposited onto the chip to potentially reduce the thermal resistance 0.1-0.2° C. cm²/W from current best-in-class commercial technologies, which can lead to significantly cooler devices (40° C. at 200 W/cm² background heat flux). This enhanced cooling stems from a thermal resistance reduction of ˜0.1° C. cm²/W at the package interfaces (US 2022/0055153 A1, U.S. Pat. No. 11,167,375), and a reduction in the heatsink resistance of about ˜0.1° C. cm²/W due to higher conductivity fins and improved design. The technology can enhance reliability by about >10 times, while shrinking the size and weight of the cooling device by over 50%, compared to conventional cooling devices. Alternatively, this enhanced cooling can boost performance 20-50% with unchanged reliability. These estimates are owing to electronic devices becoming ˜5% more efficient and doubling their mean time to failure for a 10° C. reduction in silicon transistor temperature. Industrial diamond is cost effective in this application.

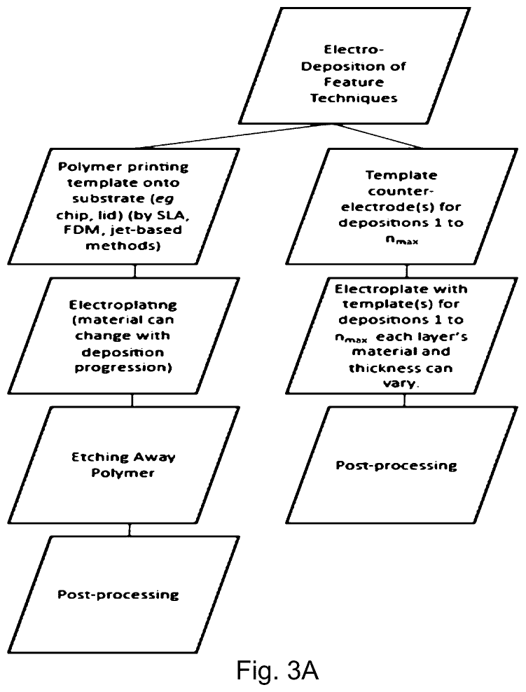

FIG. 3A shows a schematic illustrating elements of the technology, which embodies electrochemical methods of making structures.

FIG. 3B shows a schematic illustrating elements of the technology, which embodies postprocessing of the structures.

One embodiment fabricates a 3D printed diamond metal matrix composite of high thermal conductivity. In certain embodiments, it also enables the manufacture of heat removal devices consisting of diamond-metal mixtures printed directly onto the electronic device via selective laser melting. This technique has the advantage of increasing the thermal conductivity of printed structures which results in better cooling. Additionally, thermal stresses due to coefficient of thermal expansion mismatch between the printed structure and semiconductor substrate are reduced, which improves the reliability of the thermal management device and the electronic component.

### Example 4

### Intermetallic Layer Coating on Particles

An intermetallic (also called an intermetallic compound, intermetallic alloy, ordered intermetallic alloy, and a long-range-ordered alloy) is a type of metallic alloy that forms a solid-state compound exhibiting defined stoichiometry and ordered crystal structure. Intermetallic compounds may be defined as solid phases containing two or more metallic elements, with optionally one or more non-metallic elements, whose crystal structure differs from that of the other constituents. The Hume-Rothery rules may be used to predict solid phase solutions. See,

en.wikipedia.org/wiki/Hume-Rothery_rules,

www.phase-trans.msm.cam.ac.uk/2004/titanium/hume.rothery.html.

The definition of a metal is taken to include the so-called post-transition metals, i.e., aluminum, gallium, indium, thallium, tin and lead, some, if not all, of the metalloids, e.g., silicon, germanium, arsenic, antimony and tellurium, and homogeneous and heterogeneous solid solutions of metals, but interstitial compounds (such as carbides and nitrides), are excluded under this definition. These interstitial compounds may, however, be provided as inclusions. However, interstitial intermetallic compounds are included, as are alloys of semimetal compounds with a metal. For purposes hereof, the phrase “intermetallic” compounds also encompasses certain intermetallic-like compounds, i.e., crystalline metal compounds other than halides or oxides, and including such semimetals, carbides, nitrides, borides, sulfides, selenides, arsenides, and phosphides, and can be stoichiometric, and share similar properties to the intermetallic compounds defined above, including the facilitation of layer adhesion. Thus, compounds such as cementite, Fe₃C, are included. See, en.wikipedia.org/wiki/Intermetallic. The interfacial layer may have amorphous characteristics, e.g., due to rapid cooling.

The CTE, especially of the layers nearest to the substrate, are important, as they will lead to mechanical stresses being imparted to the chip and package (e.g., solder connections) during thermal cycling. CTE matching of the metallization can be achieved by adding particles (nano to micro), or alloying (e.g., adding diamond microparticles with copper, or alloying copper-tungsten). While alloying will likely reduce alloying, adding diamond, can enhance the thermal conductivity, especially if larger diamond inclusions are added. Therefore, the concentration of particles is preferably set to achieve a target CTE, rather than simply maximizing the thermal transfer. Where the optimal CTE is within a range, the concentration of particles may be secondarily optimized for thermal transfer, mechanical properties, manufacturing feasibility, etc.

The matching solid additives can be suspended in the electroplating bath, so to be included on the surface through settling or convection, or deposited external to the bath. The particles can serve dual purposes, (1) to match CTE or (2) enhance thermal conductivity, or just one of those objectives.

### Example 5

### Inclusions to be Sacrificed Through Etching

The electrochemical additive manufacturing methods can make smaller porosity features by the inclusion of sacrificial template elements. This technique has been used without additive manufacturing in the literature to make boiling enhancement structures. (131, 137, 114)

The technique works by including small spherical inclusions that are subsequently removed, by processes including dissolving, etching, burnout, or melting. This sacrificed template technique can be incorporated into the electrochemically additive process to add hierarchical porosity. Alternatively, an alloy that lends itself to dealloying can be used to achieve porosity down to nanometer scale. (123, 134) The printed design can be a uniform initial layer to improve boiling at the surface of the lid/heat spreader or chip over the entire surface and then fins of a height that utilizes the material efficiently (e.g., fin tip is still significantly above the temperature of the free fluid). Subsequent layers can benefit from exterior porosity/roughness to enhance boiling, if the cooling mode is two-phase (e.g., boiling or evaporation). Boiling enhanced fins and single-phase forced liquid convection don't need to be very tall, owing to the high heat transfer coefficient relative to air forced convection. One key aspect is improving the thermal contact to the substrate.

The technology in some implementations may also use high-fluence laser (e.g., nanosecond to femtosecond pulses) to ablate material to create boiling nucleation sites. These nucleation sites can trap vapor, so to also reduce superheating required to initiate boiling. These holes can serve as re-entrant cavities for two-phase boiling.

### Example 6

### Strike Layer

As used herein, a “strike layer” refers to a layer of material on a surface or part of a surface. The strike layer is intended to work as an intermediary or connecting bridge between two components. The strike layer may be used to join two materials that otherwise would not be able to directly bond to each other. In some embodiments, the strike layer may be a coating or layer added to the outside of a component, but in other embodiments, the strike layer may be part of the thickness of the component itself. Thus, the strike layer may refer to a portion of the thickness of a surface that is intended to work as an intermediary or connecting bridge between the surface and another surface.

A strike solution is a low concentration plating solution intended to form a thin initial plating layer which could not be formed or would be poorly formed in a full-strength solution. Two typical examples: 1). Silver is a noble metal that tends to “immersion deposit” onto other metals with no electricity applied, resulting in a poorly adherent deposit. To deal with this, part of the approach is to do an initial thin layer in a dilute silver “strike solution” and then follow this up with heavier silver plating from a stronger solution. 2). Plating with good adhesion onto stainless steel is difficult because a passive oxide layer immediately forms on the stainless, and you want to plate onto metals, not onto oxides. Very acidic but somewhat dilute nickel plating solutions called “Wood's Nickel Strike” or “Sulphamate Nickel Strike” can simultaneously dissolve the passive layer and deposit a fresh but thin nickel layer on it, which allows subsequent electroplating with nickel or other metals.

An electrochemical method according to the present technology prints a template onto a substrate. If this substrate does not have a conductive film, an adhesion/strike layer is added via methods discussed above. This template may be a dissolvable polymer, similar to that used for removable support in conventional additive manufacturing for ease of later removal. However, the template can be removed by a plethora of methods (e.g., by dissolving, melting, chemically removing, or etching). A negative version of the electrodeposited part should be made using a printed polymer, e.g., stereolithographic method (SLA), fused deposition modeling (FDM), jetting, etc. The template may be interconnected to facilitate its removal. However, if the metal is made porous later, by for instance dealloying, then it may not need not be interconnected. Then electroplating can proceed. The deposition can switch metal deposited to suit the application. The non-templated region can be potentially filled with additives (as described earlier for reasons including thermal conductivity enhancement, and/or CTE matching). Finally, the printed template mold can be removed, as discussed above. This can be combined with prior postprocessing methods, e.g., final erosion/corrosion electroplating, boiling enhancement coatings, polymer coatings, and wetting modifying coatings.

### Example 7

### Counter-Electrode Template

Another method of printing embodied herein suitable for mass production, uses a counter electrode template, preferably conductive but not consumed, that electrodeposits each layer. The templates of this printing method can be a conductive electrode (e.g., graphite) that is etched or has an insulating layer printed on it. Different templates can be used for different layers. Each layer can be of variable thickness and material composition (including gradient), and potentially include additives. The alignment of the templates can be achieved by fiducial markers. The templates can be porous to allow flow of electroplating solution through it. The benefit of this method is that it enables 3D designs but without needing specialized addressable electroplating arrays. Especially if the same design is printed over many layers, this can be helpful. The build plate is moved at a controllable rate from the template electrode, maintaining a gap. The buildplate can rise out of the electroplating bath, so as to not deposit metal accidentally on previously printed layers.

### Example 8

### Addition of Polymer Manifolds to Electrochemical Cooling Designs

In some implementations, after the additive manufacturing and cleaning processes is complete, another step of material deposition may be performed by other means such as chemical electrodeposition or room-temperature sintering to modify the printed material (e.g., porosity, surface area and surface roughness of the additively formed structures).

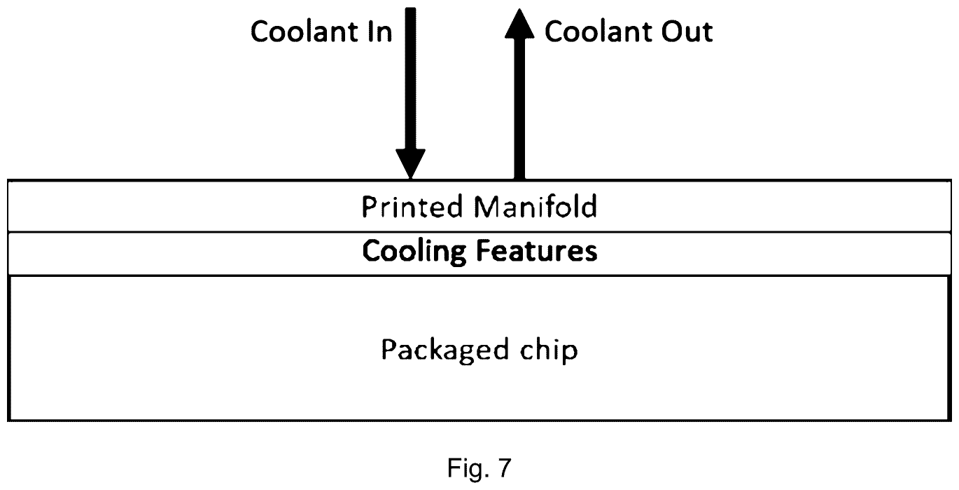

FIG. 7 shows a printed polymeric manifold directly on metal cooling features of a chip or chip underlying substrate.

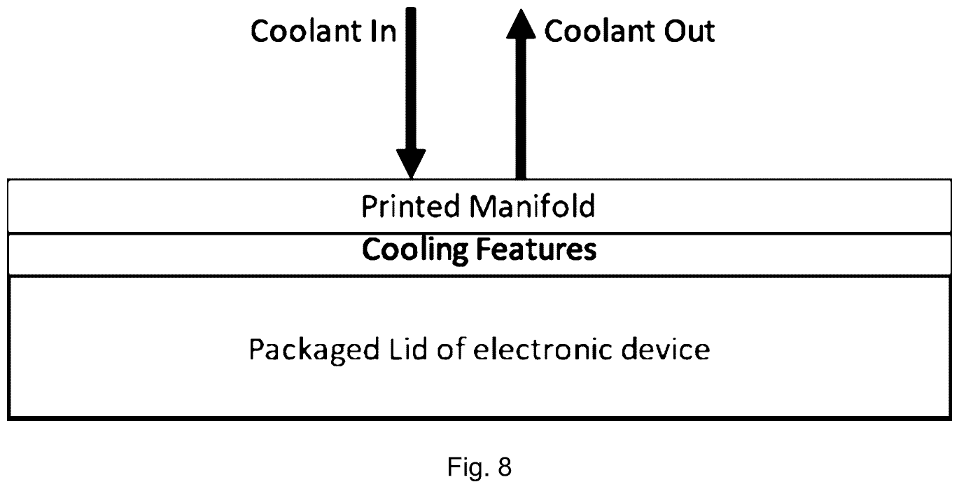

FIG. 8 shows a printed polymeric manifold directly on metal cooling features of lid.

In some implementations the printed features serve as electronic connections onto the lid. These electronic connections include power electronic leads or antenna arrays. The electrical connections can serve, in addition to for electrical purposes, and as thermal heatsinks. For instance, a groundplate may also serve as a wick, and antennas may also serve as fins.

In some implementations, a manifold can be attached to the heat spreader or boiling enhancement structure for fluid delivery and extraction. This manifold can be printed or made conventionally, or according to aspects of the technology. The manifold can be printed in some applications directly onto the lid, chip or chip package, or made separately (additively or conventionally) and bonded via adhesives or sealed by an O-ring or gasket. The same cassettes/build platforms described above can be used to print directly onto the lids or devices, so planarity is already known for the polymer processing. The polymer processing can use a light-cured polymer or thermal plastics or epoxy type polymers.

The manifold structure may be printed by electrochemical means simultaneously with the other device printing. This manifold can include a metal manifold or partial manifold (e.g., manifold base). A manifold base could in some embodiments take the form of a perimeter contour line that acts as a structures on which separate upper manifold can be bonded, adhered, soldered, brazed, O-ring/gasket sealed. The manifold that would be attached to an electrochemically printed manifold base could be made of metal or polymer that is manufactured by conventional or additive means.

The manifold can be electrochemically plated to reduce refrigerant leakage through the polymer manifold. This can be by electroless plating or conventional electroplating with strike layer or slightly conductive polymer.

The manifold O-ring, gasket or adhesive seal to the lid can have an electrochemically deposited metal seal to lower leakage rates for better sealing. This can be by electroless plating or conventional electroplating with strike layer or slightly conductive polymer in the O-ring.

The thin gap between the manifold and the lid can be sealed by electrodeposition directly in some instances.

The thin gap between the manifold and the lid can be sealed by a low-melting point alloy.

For the case of light cured polymer manifold, the lids or device can be submerged in a vat. A light can cure polymer selectively in space. The curing step can occur while in the vat.

The first layer may benefit from different processing than subsequent layers. The wick may be hard to seal against, so a perimeter of the cooling manifold should be made against a relatively non-porous surface. This printing will be able to handle z-height protrusions of the textured cooling device that protrudes beyond the plane of the seal. This may require some compensation in the initial printed manifold layers. The printed manifold and any substrate that it is bonded to can have the non-cured polymers rinsed out by a liquid. Any support material can be removed. Additional polymer curing (cross-linking) can occur via a UV light source, as needed.

Fused deposition can also be used to produce polymer manifolds. The g-code should be developed to consider the extruder size, so it does not crash into the printed cooling structures previously deposited. The deposition of the FDM part must consider thermal stress and overhangs more than SLA, and also has generally coarser resolution, so could be less desirable.

The manifold material should be compatible with the refrigerant or dielectric liquid used. This can be tested by swelling and weight gain of the polymer in the refrigerant, mechanical testing and permeation testing. It can also be assessed by the rate at which a container made of a material of question loses refrigerant or dielectric liquid. The addition of elements to the polymer, like BN, or additional metallizations, by evaporation or sputtering or electroless electroplating, can help reduce leakage rates.

In some implementations the manifolds can be printed and attached by an adhesive, but direct printing of the manifolds offers potential benefits in terms of tighter sealing. It also diminishes need for an O-ring, which is a potential leakage point.

### Example 9

### Electronic Component “Skyline” Bridging

In many electronics packages, especially in mobile electronics, aerospace, and defense, there are printed wiring boards with a plethora of components of different heights that have to thermally connect to either a heatsink or another printed wiring board with its own set of components of different heights separated by a small gap. The profile of the different chips protruding above the printed wiring board forms a surface (commonly referred to as a “skyline”). The gap in-between skylines of two boards facing each other pose a significant thermal challenge in many mobile applications. The gap between a skyline and a cooled plate also often requires computer numerical control (CNC) machining to reduce gaps for aerospace and defense applications that have discrete card computing units. In certain embodiments, the skyline gap can be thermally bridged.

In particular, for skyline gaps, there are advantages to filling that space with a high thermal conductivity filler with dimensions matching the skyline(s). At the same time, the thermal gap solution that allows rework in case of failed component, enables mechanical survivability in case of mechanical stress from shock (e.g., dropping), does not suffer from imposing thermal stresses large enough to damage, has high thermal conductivity, is electrically insulating, are desired.

In some embodiments, the skyline can have on it an electrically insulative coating, followed by a conductive coating, on which an electroplated metal layer can be deposited. The insulative coating can be deposited by a paint/lacquer, physical vapor deposition or chemical vapor deposition. The metal strike layer can be achieved by a paint (e.g., graphite flakes in evaporative solvent, or graphitic flakes in evaporative solvent with binder), or by electroless deposition, or by physical vapor deposition or chemical vapor deposition. This can be followed by electroplating.

In some embodiments, deposition by electroplating can occur with solid inclusions that improve the thermal conductivity. In the case of multiple boards, in some embodiments, each board can be coated separately, polished smooth as needed, and then thermally bridged with a thin thermal interface material. If one board needs to be connected to a coldplate, the electroplating on one skyline can be completed and abraded flat, need be, to match.

This solution has greater utility if the skyline thermal bridge insert can be reworked by cleanly separating from the printed wiring board. Using an electrically insulating coating that loosely bonds to the surface or a strike layer that is only weakly bonded to the insulator layer, can enable facile rework. The interface between the electronic package and the strike layer can contain an elastomeric component to help absorb shock absorption for mobile applications, in some embodiments as part of a dielectric layer. Graphite strike layer with no binder, or weak binders, can achieve the weak bonding desired for needed reworkability.

In some embodiments, a metal powder (e.g., Cu) held in a shape of desired skyline insert can be filled in by electroplating to fill in the gaps. In some cases, an incompletely filled insert is desired, so to allow some flexibility, lower mechanical moduli, and shock absorption. In some applications, the metal powder will be mixed with inclusions, e.g., diamond, including carbide-coated diamond, graphite, carbon nanotubes.

In some embodiments provide solutions to this skyline problem. A template can be used to electroplate a near-fit insert that is high thermal conductivity. The coefficient of the insert may be matched by use of inclusions. The insert can leave a thin gap that is filled with shock absorbing elastomeric polymer. This polymer film can also be electrically insulating. Additives to the polymer that increase thermal conductivity, similar to TIM solutions might be desired.

### Example 10

Overview of Inclusion Electroplating with Variable Porosity

A fabrication process for a material is provided that is a composition of inclusions connected together with an electroplated material that bonds the inclusions to each other and to the substrate with variable porosity between these connections. This technology enables wicks of variable porosity made of inclusions to make materials including porous copper-diamond composite and porous copper for use in high-efficiency heat sinks and customized thermal management structures. A 3D-printed polymer substrate made conductive using graphite paint or an electroless plating layer, can serve as the base for electroplating a solid structure with inclusions. In some implementations, copper powder (mean size 30 mesh) and other applications diamond particles (mean size 40 microns) coated in a conductive layer are suspended in an electroplating bath with a controlled agitation and deposition cycle to enable uniform distribution and strong bonding in the composite. The process creates a porous copper matrix with adjustable porosity to balance thermal conductivity and structural integrity and tailorable for applications requiring customized geometries. Typically porosities of 30%-45% are achieved. This method allows direct electroplating of complex shapes, making it adaptable for various device architectures and significantly improving heat dissipation performance in electronic systems. This approach addresses the increasing demand for materials that exhibit high thermal conductivity, low thermal expansion, porosity and integration flexibility across electronic devices.

Industry makes many wicks by conventional sintering that melts the surface of the metal particles, leading to necking and interconnected pores between powder particles, but this thermal process is not amenable to applications that cannot tolerate thermal excursions. This method is not conducive to the addition of high thermal conductivity inclusions. Sintered copper with CVD grown graphene coatings vs sintered without treatment have been examined, and a 24% to 5% enhancement in boiling heat transfer coefficient was found. This high thermal conductivity treatment covered the outside of the powder particles. The thermal conductivity was not measured, but likely only modestly improved thermal conductivity. (99) The thermal resistance of the wick is largely a function of its thermal conductivity.

Many thermal applications can benefit from the inclusion of diamonds due to their exceptional thermal conductivity (over 2,000 W/m· K) and low CTE (2.3× 10 ⁻⁶ K ⁻¹). (100) Prior literature has incorporated diamonds by vacuum infiltrating Cu where the diamonds were carbide with molten salt and then coated by electroless copper (101); by infiltration of Cu with diamonds coated by diffusion of metal from metal oxides at high temperatures (102, 103); by melt infiltration of monodispersed diamond (60 vol %) with an AlSi alloy with and without SiC coatings and optional heat treatment (104); Cr-diamond composites made by molten salt bath coating diamond in thick carbide films of Cr7C3 and then hot press sintering a composite (105). Related studies have looked at the influence of molten salt bath processing conditions on chromium carbide coating thicknesses (106).

Sedimentation plating of diamond that was uncoated and coated in TiC plus an additional Cu film achieved diamond concentrations of 30-45% onto a horizontal surface coated in silver paint (107,108), and deposited untreated diamond on a horizontal surface and then electroplated (109). Beyond diamond, sediment co-deposition has also been used to add nanoparticles like Al₂O₃ (110) to metals, and to add Al particles to Ni (111).

This technology can be applied to a chip surface (e.g., Si, SiC, GaN, etc.) with a removable film, like sprayed graphite. The technology can also be made on one surface with a spray coating (like graphite) that can be removed and later transferred to a chip. The substrate can be a non-stick or low-stick film (like Teflon® or silicone) or may be heat debondable in a manner that enables debonding and transfer to chips.

The colloidal particles can be agitated by a magnetic stirrer rod, ultrasonic energy, or by a pump. The particles settling rate and agglomeration can be controlled by an optional surfactant. The concentration of particles in the solution can be monitored and replenished. A computer feedback loop can monitor transparency or concentration in another method and adjust stirrer agitation speed in a supply tank that has sediment in the bottom to keep concentration as desired.

Other inclusions like graphene and CNTs can also be made into porous frameworks by this method. Surfactants can aid in dispersing these nano and microparticles.

As a post-processing step, the porous part can optionally be coated with an additional material. This additional coating can be to prevent oxidation and/or modify wetting. It can be done by electroplating or electrolysis electroplating, chemical or physical vapor deposition. For instance, a Ni film coating Cu sinter or Cu-diamond sinter could reduce oxidation-related fouling of the wick.

Another optional post-processing step is a dealloying step to create another level of porosity and microstructure. Dealloying can create sponge like porosity inside the solid-phase of porous structure, creating two levels of porosity.

### Example 11

### Inclusion Electroplating Specific Technology

### Step 1: Specific Example for Non-Conductive Substrates

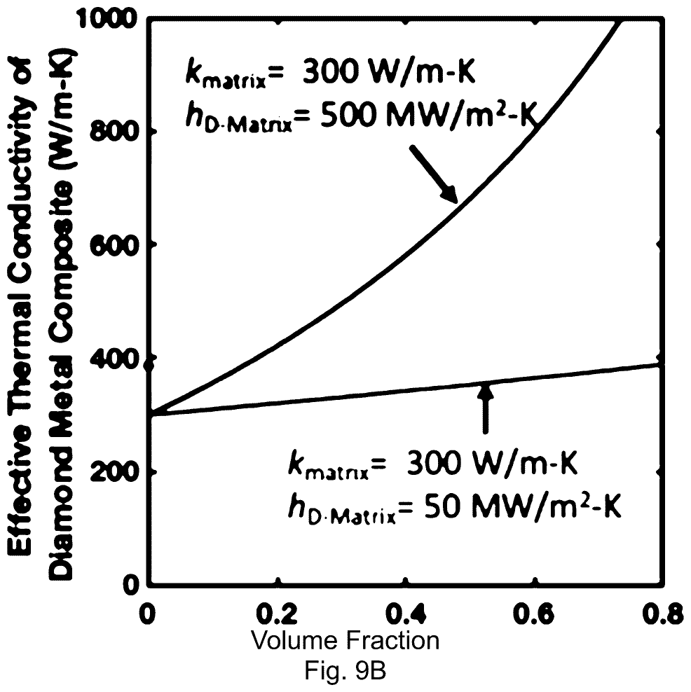

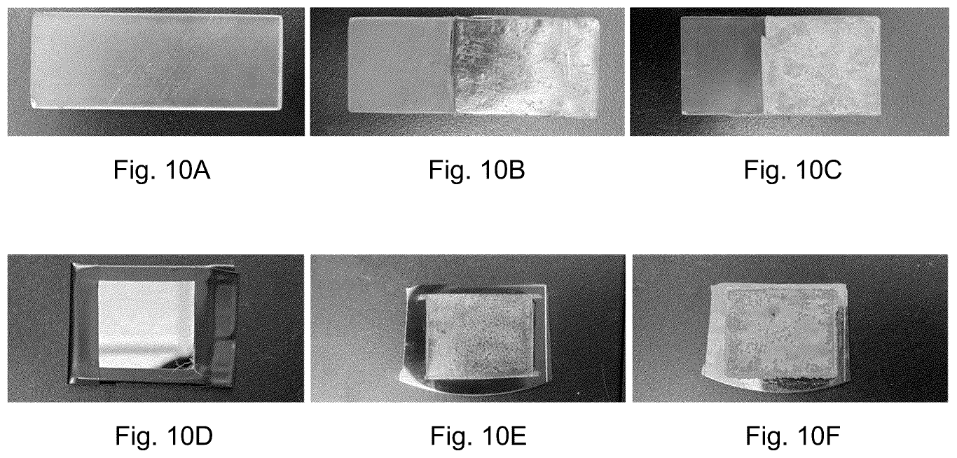

The fabrication process starts with a 3D-printed polymer substrate, which acts as the foundation for copper electroplating (FIG. 10A). First, the polymer substrate is thoroughly cleaned with isopropanol and acetone to remove any organics, dust, or impurities. This cleaning step ensures an uncontaminated surface for further processing. Once cleaned, the substrate is coated with a layer of graphite paint and applied with a spray gun to create a conductive surface. This graphite layer enables the non-conductive polymer to function as a cathode during the electroplating process. After allowing the graphite paint to dry, the coated substrate is carefully sanded using progressively finer grades of sandpaper (600, 800, and 1200 grit) to achieve a smooth, even surface. Following this sanding, the substrate is cleaned again to eliminate any residual dust or particles generated during sanding (FIG. 10B). Alternatively, the polymer substrate can be made conductive through other methods of applying an electrically conductive strike layer. This layer may be added via electroless deposition, physical vapor deposition (e.g., sputtering, evaporation, plasma-enhanced sputtering), chemical vapor deposition (e.g., atomic layer deposition), thermally applied layers (e.g., laser powder fusion), cold spray methods, conductive adhesives including silver epoxy, liquid metal films. Each technique provides flexibility based on substrate compatibility and desired properties. With the conductive surface prepared, the substrate is connected to the cathode terminal of a power supply. The electroplating bath is then prepared, containing a copper sulfate solution composed of 240 g/L of copper sulfate pentahydrate (CuSO₄·5H₂O) and 46 g/L of sulfuric acid (H₂SO₄), with a total volume of 500 mL. The prepared polymer substrate, now the cathode, is immersed in this solution bath. Two copper bars, each with dimensions of 1 mm×25 mm×150 mm, are connected to the anode terminal of the power supply and are also immersed in the bath. The electroplating process is conducted at room temperature (approximately 23° C.) by applying a current density of around 12-37 mA/cm². This current causes copper ions in the solution to deposit onto the surface of the polymer substrate. The electroplating continues until the copper layer reaches the desired thickness. Once the process is complete, the sample is removed from the solution bath, and the polymer substrate is optionally abraded smooth (FIG. 10C).

Step 2: For Electroplated Diamond Material with Second-Phase Copper for Porous Diamond-Copper Composite

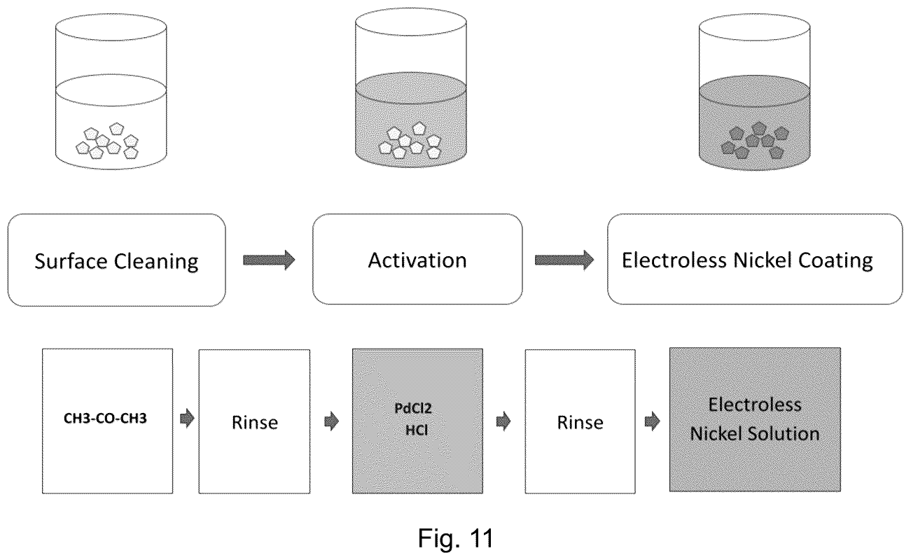

The fabrication process for embedding diamond powder into a copper matrix to create a copper-diamond composite starts with treating the diamond powder to make it conductive. Diamond powder with a mean particle size of 40 μm (FIG. 12A) undergoes an electroless metal plating process for this purpose. The process begins with cleaning the diamond powder in acetone to remove dust and impurities, followed by rinsing in deionized water.

Next, the powder undergoes a sensitization step, where it is immersed for 2-4 minutes in a sensitizing solution (SnCl 30 g/L and HCl 50 mL/L), and then rinsed again in deionized water. Following sensitization, the diamond powder is activated for 2-4 minutes (PdCl₂ 0.5 g/L and HCl 10 mL/L), and then rinsed again. The activated diamond particles are then submerged in an electroless metal bath. This example used a proprietary commercial plating bath. After plating, the diamond powder is rinsed with deionized water to remove any remaining acid or bath components (FIG. 12B).

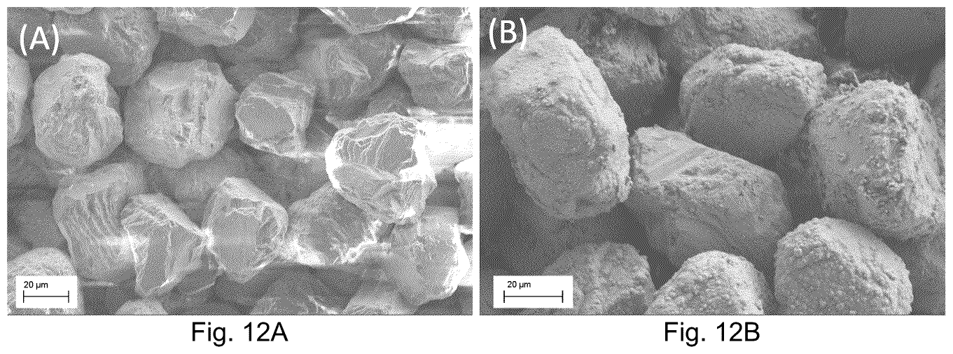

The treated diamond powder is introduced into a 250 mL electroplating bath containing 240 g/L of copper sulfate pentahydrate (CuSO₄·5H₂O) and 46 g/L of sulfuric acid (H₂SO₄). To ensure the copper and coated diamond powders are evenly dispersed within the solution, a magnetic stirrer is used to mix the powders at a constant speed of 200 RPM. The substrate is connected to the cathode terminal, while two copper bars (1 mm×25 mm×150 mm) serve as anodes, wrapped with filters to capture any residue or oxides formed during electroplating. The electroplating process proceeds with a current density of 25 mA/cm² and involves an alternating cycle of stirring and electroplating to embed the copper-coated diamond particles into the growing copper matrix for nearly fully dense copper-diamond composite. The solution is initially stirred for 30 seconds to promote even distribution of the copper-diamond particles in the bath, followed by 10 minutes of electroplating. This cycle is repeated with precise timing until the desired thickness is achieved. Every 5 hours 1 g of powder was replenished into the bath to maintain powder concentration and ensure consistent embedding. Once the desired thickness is reached, the sample is removed (FIGS. 13A and 13B). The resulting porous copper-diamond composite exhibits enhanced thermal conductivity and structural integrity due to the uniform distribution of diamond particles throughout the copper matrix.

For comparison, samples of pure copper without diamond, diamond with electroless Cu pre-treatment and Cu matrix (20 vol %), and diamond with electroless Ni pre-treatment and Cu matrix (5 vol %) (preferred) were prepared. The thermal conductivities of these samples were measured by flash diffusivity to be 400±5 W/(m-K), 378±7 W/(m-K), and 474±7 W/(m-K), respectively. This indicates a significant improvement in thermal properties by using a Ni interlayer, owing to its intermediate phonon spectra that bridges the phonon spectra differences from diamond to Cu. The coefficient of thermal expansion of pure copper without diamond was measured to be 17.6×10⁻⁶ 1/K, porous diamond-Cu was measured to be 15.5×10⁻⁶ 1/K at a diamond volume of 5% and 10.1×10⁻⁶ 1/K at a diamond volume of 20%.

The addition of Ni, Cr, Co would aid conductance due to their phonon spectra as characterized by the Debye temperature being intermediate to diamond and Cu, and are covered as potential embodiments. Alternative embodiments could employ intermediate interlayers with phonon bridging properties including carbides like TIC, HfC, TaC, Cr₃C₂, Mo₂C, and metal nitrides. In these alternative embodiments the carbide or other interlayers can be deposited by pretreatment by electroplating (potentially in non-aqueous solution) and optional thermal treatment, ionic liquid electroplating with optional thermal treatment, molten salt carbiding, physical vapor deposition (PVD), chemical vapor deposition (CVD), atomic layer deposition (ALD), thermal diffusion, solution-based methods. The material could alternatively use other metals to make the matrix, like Ag, instead of Cu.

In some implementations, alternatives to sedimentation could be applied, including electrophoretic deposition (EPD) as described in U.S. Pat. No. 6,258,237, or Langmuir-Blodgett self-assembled monolayer deposition. The present technology is distinct from U.S. Pat. No. 10,221,498, which coats a sacrificial preform with diamond and copper nanoparticles via electrophoresis, and U.S. Pat. No. 6,258,237, which describes EPD of diamond, in several key ways. These prior technologies do not address deposition onto dissimilar, non-conductive substrates, nor do they incorporate strategies to reduce thermal stress through coefficient of thermal expansion (CTE) matching with a heat-dissipating substrate. Unlike the thin (10-100 s of microns) films deposited in U.S. Pat. Nos. 10,221,498 and 6,258,237, the present technology enables thicker layers of deposited material, using a removable physical mask in some embodiments, eliminating the need for thermal processing. Both prior processes rely on a thermal step to remove a preform and sinter nanoparticle metal, which is incompatible with direct manufacturing onto electronic devices. Furthermore, neither prior technology enhances thermal conductivity as much as certain embodiments of this technology, as these two patents lack interlayers that bridge the thermal spectrum mismatch between diamond and metal matrix. U.S. Pat. No. 10,221,498 specifically focuses on nanoparticle-sized diamond and copper, whereas the present technology prefers larger (10 s to 100 s of microns, or even mm-scale) diamond particles—as metal-diamond interfacial resistance is significant, and larger particles improve thermal conduction. Additionally, these prior patents do not describe controlled porosity for phase-change heat transfer applications, such as wicks for vapor chambers, heat pipes, and two-phase cold plates.

### Step 2: For Electrodeposition of a Porous Material

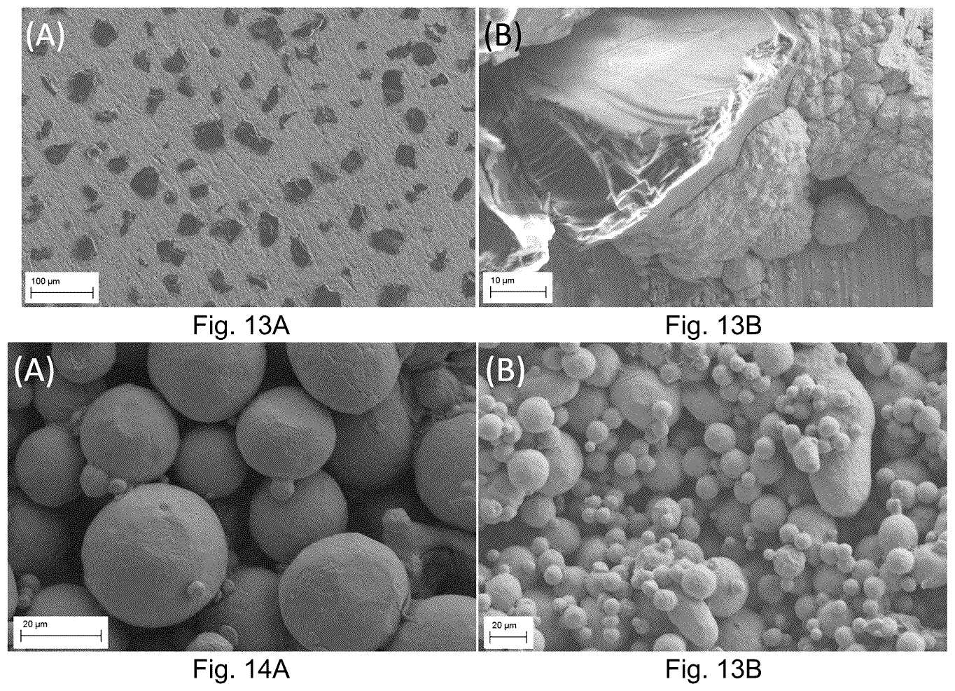

Electrodeposition of a copper porous powder by electrodeposited Cu is therefore demonstrated, and the technique is adaptable to diamond and other inclusions with or without pretreatment. The fabrication process here describes one specific example of making a porous material of a powder phase by electroplating a metal phase using Cu powder with Cu electrodeposition. The process begins with cleaning the copper powder (30 μm mean diameter, FIG. 14A) with acetone to eliminate any dust, grease, or impurities. After cleaning, 1.5 grams of the copper powder is added to a 250 mL electroplating bath containing 240 g/L of copper sulfate pentahydrate (CuSO₄·5H₂O) and 46 g/L of sulfuric acid (H₂SO₄). To ensure the copper powder is evenly dispersed within the solution, a magnetic stirrer is used to mix the powder at a constant speed of 200 rpm. This mixing step is critical for preventing clumping and promoting uniform distribution of the powder. The sample is suspended at a 30-degree angle from horizontal. The sample is connected to the cathode terminal of a power supply, while two copper bars (each measuring 1 mm×25 mm×150 mm) are attached to the anode terminal. Each anode bar is wrapped in a filter to capture any residue or copper oxide that may form during the electroplating process, maintaining the bath's purity. For electroplating, a current density of 25 mA/cm² is applied. Initially, the bath is stirred at 200 rpm for 30 seconds to ensure thorough mixing of the copper powder within the solution. This stirring helps settle some of the powder onto the exposed substrate surface. Following the initial stirring phase, the system undergoes electroplating for 10 minutes. To control the porosity the plating time needs to be varied, during which copper ions from the solution are deposited onto the substrate surface, embedding the powder layer by layer. This process of stirring and then electroplating is repeated in timed cycles to achieve a uniform deposition of copper powder across the substrate. To maintain the concentration of copper powder, 1 gram of fresh copper powder is added to the solution every 5 hours. This gradual addition of powder ensures continuous embedding of particles into the growing copper matrix, building a composite layer by layer until the target thickness is achieved. Once the electroplating reaches the desired thickness, the sample can be removed from the solution (FIG. 14B). Post-processing can be done for dimensional accuracy, to add an outer coating, add additional porosity by dealloying or other chemical treatments, coatings for corrosion/oxidation and erosion resistance (e.g., Ni or Cr thin film).

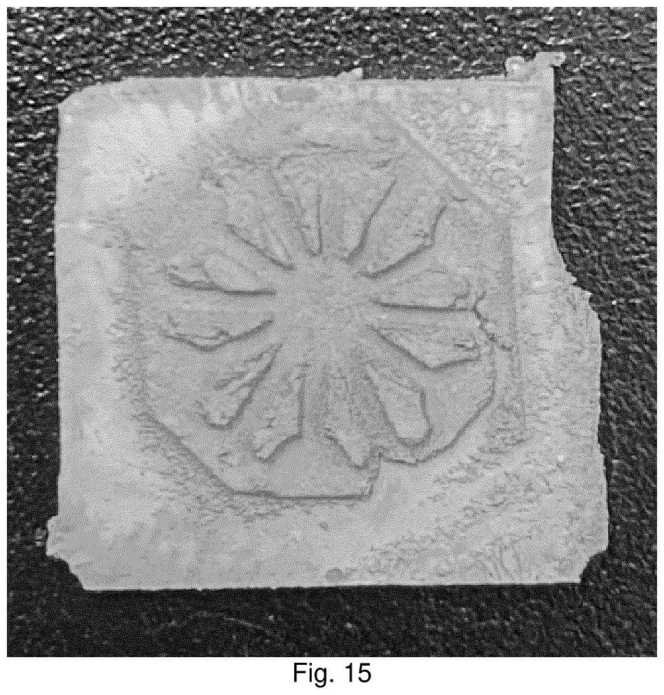

With this and other compositions, masks that block off certain areas, can also be used, and was demonstrated in FIG. 15. This mask was made of a flat polymer where deposition only occurs in the non-covered region. Similar masking could occur digitally by a digitally addressable counter-electrode, though precise control of the diamond diameter to not clog the narrow separation would be required. Periodic pausing of the electroplating fluid over the workpiece can in some embodiments replace the periodic stirring near the workpiece used to suspend and deposit the particles.

Thus, have been shown various embodiments, Further modifications, combinations, subcombinations, and permutations of the disclosed technology will be apparent to those of ordinary skill in the art.

REFERENCES (Each of which is expressly incorporated herein by reference)
1. Loterie D, Delrot P, Moser C. 2020. High-resolution tomographic volumetric additive manufacturing. Nat. Commun. 11:852.
2. Gibson I, Rosen D, Stucker B. 2015. Additive Manufacturing Technologies: 3D Printing, Rapid Prototyping, and Direct Digital Manufacturing. New York: Springer.
3. Aejmelaeus-Lindström P, Rusenova G, Mirjan A, Medina Ibáñez J, Gramazio F, Kohler M. 2020. Rock print pavilion: robotically fabricating architecture from rock and string. Constr. Robot. 4:97-113.
4. Sturmer J. 2015. 3D printing: Australian researchers create jet engine, breakthrough captures attention of Airbus and Boeing. ABC News, February 25. www.abc.net.au/news/2015-02-26/australian-researchers-create-first-3d-jet-engine/6262462.
5. LaFratta C N, Fourkas J T, Baldacchini T, Farrer R A. 2007. Multiphoton fabrication. Angew. Chem. Int. Ed. 46:6238-58.
6. Fischer J, Wegener M. 2013. Three-dimensional optical laser lithography beyond the diffraction limit. Laser Photon. Rev. 7:22-44.
7. Stampfl J, Liska R, Ovsianikov A. 2016. Multiphoton Lithography: Techniques, Materials, and Applications. Weinheim, Ger.: Wiley-VCH Verlag.
8. Lamont A C, Restaino M A, Kim M J, Sochol R D. 2019. A facile multi-material direct laser writing strategy. Lab Chip 19:2340-45.
9. Pearre B W, Michas C, Tsang J M, Gardner T J, Otchy T M. 2019. Fast micron-scale 3D printing with a resonant-scanning two-photon microscope. Addit. Manuf. 30:100887.
10. Hahn V, Messer T, Bojanowski N M, Curticean E R, Wacker I, et al. 2021. Two-step absorption instead of two-photon absorption in 3D nanoprinting. Nat. Photon. 15:932-38.
11. Geng Q, Wang D, Chen P, Chen S C. 2019. Ultrafast multi-focus 3-D nano-fabrication based on two-photon polymerization. Nat. Commun. 10:2179.
12. Yang L, Hu H, Scholz A, Feist F, Cadilha Marques G, et al. 2023. Laser printed microelectronics. Nat. Commun. 14:1103.
13. Gamburg Y D, Zangari G. 2011. Theory and Practice of Metal Electrodeposition. New York: Springer.
14. Ansari R. 2006. Polypyrrole conducting electroactive polymers: synthesis and stability studies. E-J. Chem. 3:860413.
15. Kim S, Jang L K, Park H S, Lee J Y. 2016. Electrochemical deposition of conductive and adhesive polypyrrole-dopamine films. Sci. Rep. 6:30475.
16. Akbulut H, Yavuz M, Guler E, Demirkol D O, Endo T, et al. 2014. Electrochemical deposition of polypeptides: bio-based covering materials for surface design. Polym. Chem. 5:3929-36.
17. Ammam M. 2014. Electrochemical and electrophoretic deposition of enzymes: principles, differences and application in miniaturized biosensor and biofuel cell electrodes. Biosensors Bioelectron. 58:121-31.
18. Rodolfa K T, Bruckbauer A, Zhou D, Korchev Y E, Klenerman D. 2005. Two-component graded deposition of biomolecules with a double-barreled nanopipette. Angew. Chem. Int. Ed. 44:6854-59.
19. Zhang Z, Kitada A, Fukami K, Yao Z, Murase K. 2020. Electrodeposition of an iron thin film with compact and smooth morphology using an ethereal electrolyte. Electrochim. Acta 348:136289.
20. Luo B, Yang D, Liang M, Zhi L. 2010. Large-scale fabrication of single crystalline tin nanowire arrays. Nanoscale 2:1661-64.
21. Tonelli D, Scavetta E, Gualandi I. 2019. Electrochemical deposition of nanomaterials for electrochemical sensing. Sensors 19:1186.
22. Jabbar A, Yasin G, Khan W Q, Anwar M Y, Korai R M, et al. 2017. Electrochemical deposition of nickel graphene composite coatings: effect of deposition temperature on its surface morphology and corrosion resistance. RSC Adv. 7:31100-9.
23. Liu A, Li C, Bai H, Shi G. 2010. Electrochemical deposition of polypyrrole/sulfonated graphene composite films. J. Phys. Chem. C 114:22783-89.
24. Hengsteler J, Mandal B, van Nisselroy C, Lau G P S, Schlotter T, et al. 2021. Bringing electrochemical three-dimensional printing to the nanoscale. Nano Lett. 21:9093-101.
25. Ercolano G, Zambelli T, van Nisselroy C, Momotenko D, Vörös J, et al. 2020. Multiscale additive manufacturing of metal microstructures. Adv. Eng. Mater. 22:1900961.
26. Reiser A, Linden M, Rohner P, Marchand A, Galinski H, et al. 2019. Multi-metal electrohydrodynamic redox 3D printing at the submicron scale. Nat. Commun. 10:1853.
27. Ercolano G, van Nisselroy C, Merle T, Vörös J, Momotenko D, et al. 2020. Additive manufacturing of sub-micron to sub-mm metal structures with hollow AFM cantilevers. Micromachines 11:11010006.
28. Park Y-G, Yun I, Chung W G, Park W, Lee D H, Park J-U. 2022. High-resolution 3D printing for electronics. Adv. Sci. 9:2104623.
29. Hengsteler J, Lau G P S, Zambelli T, Momotenko D. 2021. Electrochemical 3D micro- and nanoprinting: current state and future perspective. Electrochem. Sci. Adv. 2: e2100123.
30. Hirt L, Reiser A, Spolenak R, Zambelli T. 2017. Additive manufacturing of metal structures at the micrometer scale. Adv. Mater. 29:1604211.
31. Je J H, Kim J M, Jaworski J. 2017. Progression in the fountain pen approach: from 2D writing to 3D free-form micro/nanofabrication. Small 13:1600137.
32. Hirt L, Grüter RR, Berthelot T, Cornut R, Vörös J, Zambelli T. 2015. Local surface modification via confined electrochemical deposition with FluidFM. RSC Adv. 5:84517-22.
33. Hirt L, Ihle S, Pan Z, Dorwling-Carter L, Reiser A, et al. 2016. Template-free 3D microprinting of metals using a force-controlled nanopipette for layer-by-layer electrodeposition. Adv. Mater. 28:2311-15.
34. Meister A, Gabi M, Behr P, Studer P, Vörös J, et al. 2009. FluidFM: combining atomic force microscopy and nanofluidics in a universal liquid delivery system for single cell applications and beyond. Nano Lett. 9:2501-7.
35. Hansma P K, Drake B, Marti O, Gould S A C, Prater C B. 1989. The scanning ion-conductance microscope. Science 243:641-43.
36. Momotenko D, Page A, Adobes-Vidal M, Unwin P R. 2016. Write-read 3D patterning with a dual-channel nanopipette. ACS Nano 10:8871-78.
37. Nakazawa K, Yoshioka M, Mizutani Y, Ushiki T, Iwata F. 2020. Local electroplating deposition for free-standing micropillars using a bias-modulated scanning ion conductance microscope. Microsyst. Technol. 26:1333-42.
38. Hu J, Yu M-F. 2010. Meniscus-confined three-dimensional electrodeposition for direct writing of wire bonds. Science 329:313-16.
39. Daryadel S, Behroozfar A, Morsali S R, Moreno S, Baniasadi M, et al. 2018. Localized pulsed electrodeposition process for three-dimensional printing of nanotwinned metallic nanostructures. Nano Lett. 18:208-14.
40. Chen X, Liu X, Ouyang M, Chen J, Taiwo O, et al. 2019. Multi-metal 4D printing with a desktop electrochemical 3D printer. Sci. Rep. 9:3973.
41. Ejjigu N, Abdelgadir K, Flaten Z, Hoff C, Li C-Z, Sun D. 2022. Environmental noise reduction for tunable resistive pulse sensing of extracellular vesicles. Sens. Actuators A 346:113832.
42. Gao R, Edwards M A, Harris J M, White H S. 2020. Shot noise sets the limit of quantification in electrochemical measurements. Curr. Opin. Electrochem. 22:170-77.
43. Guillaume-Gentil O, Potthoff E, Ossola D, Franz C M, Zambelli T, Vorholt J A. 2014. Force-controlled manipulation of single cells: from AFM to FluidFM. Trends Biotechnol. 32:381-88.
44. Aramesh M, Forró C, Dorwling-Carter L, Lüchtefeld I, Schlotter T, et al. 2019. Localized detection of ions and biomolecules with a force-controlled scanning nanopore microscope. Nat. Nanotechnol. 14:791-98.
45. Chen M, Xu Z, Kim J H, Seol S K, Kim J T. 2018. Meniscus-on-demand parallel 3D nanoprinting. ACS Nano 12:4172-77.
46. Nadappuram B P, McKelvey K, Byers J C, Güell AG, Colburn A W, et al. 2015. Quad-barrel multifunctional electrochemical and ion conductance probe for voltammetric analysis and imaging. Anal. Chem. 87:3566-73.
47. Yeshua T, Layani M, Dekhter R, Huebner U, Magdassi S, Lewis A. 2018. Micrometer to 15 nm printing of metallic inks with fountain pen nanolithography. Small 14:1702324.
48. Liao H-S, Werner C, Slipets R, Larsen P E, Hwang I-S, et al. 2022. Low-cost, open-source XYZ nanopositioner for high-precision analytical applications. HardwareX 11: e00317.
49. Minase J, Lu T F, Cazzolato B, Grainger S. 2010. A review, supported by experimental results, of voltage, charge and capacitor insertion method for driving piezoelectric actuators. Precis. Eng. 34:692-700.
50. Ronkanen P, Kallio P, Vilkko M, Koivo H N. 2011. Displacement control of piezoelectric actuators using current and voltage. IEEE/ASME Trans. Mechatron. 16:160-66.
51. McKelvey K, Perry D, Byers J C, Colburn A W, Unwin P R. 2014. Bias modulated scanning ion conductance microscopy. Anal. Chem. 86:3639-46.
52. Zhu C, Huang K, Siepser N P, Baker L A. 2021. Scanning ion conductance microscopy. Chem. Rev. 121:11726-68.
53. Eliyahu D, Gileadi E, Galun E, Eliaz N. 2020. Atomic force microscope-based meniscus-confined three-dimensional electrodeposition. Adv. Mater. Technol. 5:1900827.
54. Lin Y-P, Zhang Y, Yu M-F. 2019. Parallel process 3D metal microprinting. Adv. Mater. Technol. 4:1800393.
55. Galliker P, Schneider J, Eghlidi H, Kress S, Sandoghdar V, Poulikakos D. 2012. Direct printing of nanostructures by electrostatic autofocussing of ink nanodroplets. Nat. Commun. 3:890.
56. Reiser A. 2019. Additive manufacturing of metals at small length scales—microstructure, properties and novel multi-metal electrochemical concepts. Doctoral Thesis, ETH Zurich, Switzerland.
57. Guillaume-Gentil O, Grindberg R V, Kooger R, Dorwling-Carter L, Martinez V, et al. 2016. Tunable single-cell extraction for molecular analyses. Cell 166:506-16.
58. Tritton D J. 1988. Physical Fluid Dynamics. New York: Oxford Univ. Press. 2nd ed.
59. Yamada J, Matsuda H. 1973. Limiting diffusion currents in hydrodynamic voltammetry: III. Wall jet electrodes. J. Electroanal. Chem. Interfacial Electrochem. 44:189-98.
60. Momotenko D, Byers J C, McKelvey K, Kang M, Unwin P R. 2015. High-speed electrochemical imaging. ACS Nano 9:8942-52.
61. Lomax D J, Kant P, Williams A T, Patten H V, Zou Y, et al. 2016. Ultra-low voltage electrowetting using graphite surfaces. Soft Matter 12:8798-804.
62. Lei Y, Zhang X, Xu D, Yu M, Yi Z, et al. 2018. Dynamic “scanning-mode” meniscus confined electrode-positing and micropatterning of individually addressable ultraconductive copper line arrays. J. Phys. Chem. Lett. 9:2380-87.
63. Lei Y, Zhang X, Nie W, Zhang Y, Gao Q, et al. 2021. The composition and magnetic property of Co/Cu alloy microwires prepared using meniscus-confined electrodeposition: effect of [Co2+], [Cu2+] concentration at the tip of the meniscus. J. Electrochem. Soc. 168:112507.
64. Seol S K, Kim D, Lee S, Kim J H, Chang W S, Kim J T. 2015. Electrodeposition-based 3D printing of metallic microarchitectures with controlled internal structures. Small 11:3896-902.
65. Persad A H, Ward C A. 2016. Expressions for the evaporation and condensation coefficients in the Hertz-Knudsen relation. Chem. Rev. 116:7727-67.
66. Morsali S, Daryadel S, Zhou Z, Behroozfar A, Baniasadi M, et al. 2017. Multi-physics simulation of metal printing at micro/nanoscale using meniscus-confined electrodeposition: effect of nozzle speed and diameter. J. Appl. Phys. 121:214305.
67. Morsali S, Daryadel S, Zhou Z, Behroozfar A, Qian D, Minary-Jolandan M. 2017. Multi-physics simulation of metal printing at micro/nanoscale using meniscus-confined electrodeposition: effect of environmental humidity. J. Appl. Phys. 121:024903.
68. Li Y, Chen H, Xiao S, Alibakhshi M A, Lo C-W, et al. 2019. Ultrafast diameter-dependent water evaporation from nanopores. ACS Nano 13:3363-72.
69. Mkhize N, Bhaskaran H. 2022. Electrohydrodynamic jet printing: Introductory concepts and considerations. Small Sci. 2:2100073.
70. Chen C H, Saville D A, Aksay I A. 2006. Scaling laws for pulsed electrohydrodynamic drop formation. Appl. Phys. Lett. 89:124103.
71. Lindén M. 2017. Merging electrohydrodynamic printing and electrochemistry: sub-micronscale 3D-printing of metals. Master's Thesis, Uppsala Univ., Sweden.
72. Reiser A, Koch L, Dunn K A, Matsuura T, Iwata F, et al. 2020. Metals by micro-scale additive manufacturing: comparison of microstructure and mechanical properties. Adv. Funct. Mater. 30:1910491.
73. van Nisselroy C, Shen C, Zambelli T, Momotenko D. 2022. Electrochemical 3D printing of silver and nickel microstructures with FluidFM. Addit. Manuf. 53:102718.
74. Menetrey M, Koch L, Sologubenko A, Gerstl S, Spolenak R, Reiser A. 2022. Targeted additive micromodulation of grain size in nanocrystalline copper nanostructures by electrohydrodynamic redox 3D printing. Small 18:2205302.
75. Behroozfar A, Daryadel S, Morsali S R, Moreno S, Baniasadi M, et al. 2018. Microscale 3D printing of nanotwinned copper. Adv. Mater. 30:1705107.
76. Zhang X, Yuan L, Lei Y, Zhang Y, Li Y, et al. 2021. Electrochemical gradients driven 3D printing of nano-twinned copper structures by direct current dynamic meniscus confined electrodeposition. Appl. Mater. Today 24:101138.
77. Ramachandramoorthy R, Kalácska S, Poras G, Schwiedrzik J, Edwards T E J, et al. 2022. Anomalous high strain rate compressive behavior of additively manufactured copper micropillars. Appl. Mater. Today 27:101415.
78. Suryavanshi A P, Yu M-F. 2007. Electrochemical fountain pen nanofabrication of vertically grown platinum nanowires. Nanotechnology 18:105305.
79. Wang C, Hossain Bhuiyan M E, Moreno S, Minary-Jolandan M. 2020. Direct-write printing copper-nickel (Cu/Ni) alloy with controlled composition from a single electrolyte using co-electrodeposition. ACS Appl. Mater. Interfaces 12:18683-91.
80. Shen C, Zhu Z, Zhu D, van Nisselroy C, Zambelli T, Momotenko D. 2022. Electrochemical 3D printing of Ni—Mn and Ni—Co alloy with FluidFM. Nanotechnology 33:265301.
81. McKelvey K, O'Connell M A, Unwin P R. 2013. Meniscus confined fabrication of multidimensional conducting polymer nanostructures with scanning electrochemical cell microscopy (SECCM). Chem. Commun. 49:2986-88.
82. Kim J T, Seol S K, Pyo J, Lee J S, Je J H, Margaritondo G. 2011. Three-dimensional writing of conducting polymer nanowire arrays by meniscus-guided polymerization. Adv. Mater. 23:1968-70.
83. Zhang P, Aydemir N, Alkaisi M, Williams D E, Travas-Sejdic J. 2018. Direct writing and characterization of three-dimensional conducting polymer PEDOT arrays. ACS Appl. Mater. Interfaces 10:11888-95.
84. Tomaskovic-Crook E, Zhang P, Ahtiainen A, Kaisvuo H, Lee C Y, et al. 2019. Human neural tissues from neural stem cells using conductive biogel and printed polymer microelectrode arrays for 3D electrical stimulation. Adv. Healthc. Mater. 8:1900425.
85. Won K H, Weon B M, Je J H. 2013. Polymer composite microtube array produced by meniscus-guided approach. AIP Adv. 3:092127.
86. Ventrici de Souza J, Liu Y, Wang S, Dorig P, Kuhl T L, et al. 2018. Three-dimensional nanoprinting via direct delivery. J. Phys. Chem. B 122:956-62.
87. Pattison T G, Wang S, Miller R D, Liu G Y, Qiao G G. 2022. 3D nanoprinting via spatially controlled assembly and polymerization. Nat. Commun. 13:1941.
88. Liu Y, Yang J, Tao C, Lee H, Chen M, et al. 2022. Meniscus-guided 3D microprinting of pure metal-organic frameworks with high gas-uptake performance. ACS Appl. Mater. Interfaces 14:7184-91.
89. Chen M, Hu S, Zhou Z, Huang N, Lee S, et al. 2021. Three-dimensional perovskite nanopixels for ultrahigh-resolution color displays and multilevel anticounterfeiting. Nano Lett. 21:5186-94.
90. Chen M, Yang J, Wang Z, Xu Z, Lee H, et al. 2019. 3D nanoprinting of perovskites. Adv. Mater. 31: e1904073.
91. Lee J, Oh S, Pyo J, Kim J M, Je J H. 2015. A light-driven supramolecular nanowire actuator. Nanoscale 7:6457-61.
92. Oh S, Kwak E A, Jeon S, Ahn S, Kim J M, Jaworski J. 2014. Responsive 3D microstructures from virus building blocks. Adv. Mater. 26:5217-22.
93. Onses M S, Sutanto E, Ferreira P M, Alleyne A G, Rogers J A. 2015. Mechanisms, capabilities, and applications of high-resolution electrohydrodynamic jet printing. Small 11:4237-66.
94. Meng Z, Li J, Chen Y, Gao T, Yu K, et al. 2022. Micro/nanoscale electrohydrodynamic printing for functional metallic structures. Mater. Today Nano 20:100254.
95. Klein F, Richter B, Striebel T, Franz C M, von Freymann G, et al. 2011. Two-component polymer scaffolds for controlled three-dimensional cell culture. Adv. Mater. 23:1341-45.
96. Doherty R P, Varkevisser T, Teunisse M, Hoecht J, Ketzetzi S, et al. 2020. Catalytically propelled 3D printed colloidal microswimmers. Soft Matter 16:10463-69.
97. Bunea A-I, del Castillo Iniesta N, Droumpali A, Wetzel A E, Engay E, Taboryski R. 2021. Micro 3D printing by two-photon polymerization: configurations and parameters for the nanoscribe system. Micro 1:164-80.
98. Bae J, Lee S, Ahn J, Kim J H, Wajahat M, et al. 2020. 3D-printed quantum dot nanopixels. ACS Nano 14:10993-1001.
99. Ahmadi V E, Khaksaran M H, Apak A M, Apak A, Parlak M, Tastan U, et al. Graphene-coated sintered porous copper surfaces for boiling heat transfer enhancement. Carbon Trends. 2022 July; 8:100171. linkinghub.elsevier.com/retrieve/pii/S266705692200027X.
100. Yamamoto Y, Imai T, Tanabe K, Tsuno T, Kumazawa Y, Fujimori N. The measurement of thermal properties of diamond. Diamond and Related Materials. 1997 May 1; 6 (8): 1057-61. www.sciencedirect.com/science/article/pii/S0925963596007728.
101. Pan Y, He X, Ren S, Wu M, Qu X. Optimized thermal conductivity of diamond/Cu composite prepared with tungsten-copper-coated diamond particles by vacuum sintering technique. Vacuum. 2018 Jul. 1; 153:74-81. www.sciencedirect.com/science/article/pii/S0042207X1830040X.
102. Abyzov A M, Kidalov S V, Shakhov F M. High thermal conductivity composite of diamond particles with tungsten coating in a copper matrix for heat sink application. Applied Thermal Engineering. 2012 December; 48:72-80. linkinghub.elsevier.com/retrieve/pii/S1359431112003717.
103. Chuprina V G. Physicochemical interaction and structure development during the formation of metal gas-transfer coatings on diamond (review). 1. Kinetics. Powder Metall Met Ceram. 1992 Jul. 1; 31 (7): 578-83. doi.org/10.1007/BF00793435.
104. Schöbel M, Degischer H P, Vaucher S, Hofmann M, Cloetens P. Reinforcement architectures and thermal fatigue in diamond particle-reinforced aluminum. Acta Materialia. 2010 Nov. 1; 58 (19): 6421-30. www.sciencedirect.com/science/article/pii/S1359645410005082.
105. Kang Q, He X, Ren S, Zhang L, Wu M, Guo C, et al. Preparation of copper-diamond composites with chromium carbide coatings on diamond particles for heat sink applications. Applied Thermal Engineering. 2013 Oct. 2; 60 (1): 423-9. www.sciencedirect.com/science/article/pii/S135943111300402X.
106. Kim H J, Choi H L, Ahn Y S. Chromium carbide coating of diamond particles using low temperature molten salt mixture. Journal of Alloys and Compounds. 2019 Oct. 15; 805:648-53. www.sciencedirect.com/science/article/pii/S0925838819324247
107. Cho H J, Kim Y J, Erb U. Thermal conductivity of copper-diamond composite materials produced by electrodeposition and the effect of TiC coatings on diamond particles. Composites Part B: Engineering. 2018 Dec. 15; 155:197-203. www.sciencedirect.com/science/article/pii/S1359836818311247.
108. Cho H J, Tam J, Kovylina M, Kim Y J, Erb U. Thermal conductivity of bulk nanocrystalline nickel-diamond composites produced by electrodeposition. Journal of Alloys and Compounds. 2016 December; 687:570-8. linkinghub.elsevier.com/retrieve/pii/S0925838816318758.
109. Arai S, Ueda M. Fabrication of high thermal conductivity copper/diamond composites by electrodeposition under potentiostatic conditions. J Appl Electrochem. 2020 May 1; 50 (5): 631-8. Available from: doi.org/10.1007/s10800-020-01414-3.
110. Azizi-Nour J, Nasirpouri F. Exploiting magnetic sediment co-electrodeposition mechanism in Ni-Al2O3 nanocomposite coatings. Journal of Electroanalytical Chemistry. 2022 Feb. 15; 907:116052. www.sciencedirect.com/science/article/pii/S1572665722000443.
111. Liu H, Chen W. Electrodeposited Ni—Al composite coatings with high Al content by sediment co-deposition. Surface and Coatings Technology. 2005 Feb. 21; 191 (2): 341-50. www.sciencedirect.com/science/article/pii/S0257897204001847.
112. A.L.M.T. Corp., “Heatspreader applications” Accessed: Oct. 26, 2023. Available: www.allied-material.co.jp/en/products/heatspreader/Material.html#en_hsmtr02
113. Ambrosi, Adriano, Richard D. Webster, and Martin Pumera. “Electrochemically driven multi-material 3D-printing.” Applied Materials Today 18 (2020): 100530.
114. Armstrong, E., M. O'Sullivan, J. O'Connell, J. D. Holmes, and C. O'Dwyer, “3D Vanadium Oxide Inverse Opal Growth by Electrodeposition,” J. Electrochem. Soc., vol. 162, no. 14, p. D605, October 2015, doi: 10.1149/2.0541514jes.
115. Brant, Anne M., Murali M. Sundaram, and Abishek B. Kamaraj. “Finite element simulation of localized electrochemical deposition for maskless electrochemical additive manufacturing.” Journal of Manufacturing Science and Engineering 137, no. 1 (2015): 011018.
116. Brant, Anne, and Murali Sundaram. “Electrochemical additive manufacturing of graded NiCoFeCu structures for electromagnetic applications.” Manufacturing Letters 31 (2022): 52-55.
117. Braun, Trevor M., and Daniel T. Schwartz. “The emerging role of electrodeposition in additive manufacturing.” The Electrochemical Society Interface 25, no. 1 (2016): 69.
118. Chen, Xiaolei, Jiasen Chen, Krishna Kumar Saxena, Jiajun Zhu, Xiaolong Gu, and Zhongning Guo. “Localization of jet electrochemical additive manufacturing with a liquid confinement technique.” Journal of Manufacturing Processes 81 (2022): 48-64.
119. Chen, Xiaolong, Xinhua Liu, Peter Childs, Nigel Brandon, and Billy Wu. “A low cost desktop electrochemical metal 3D printer.” Advanced Materials Technologies 2, no. 10 (2017): 1700148.
120. Chiba, Y., Y. Tani, T. Enomoto, and H. Sato, “Development of a High-Speed Manufacturing Method for Electroplated Diamond Wire Tools,” CIRP Ann., vol. 52, no. 1, pp. 281-284, January 2003, doi: 10.1016/S0007-8506 (07) 60584-8.
121. Chizari, Samira, Lucas A. Shaw, Dipankar Behera, Nilabh K. Roy, Ximeng Zheng, Robert M. Panas, Jonathan B. Hopkins, Shih-Chi Chen, and Michael A. Cullinan. “Current challenges and potential directions towards precision microscale additive manufacturing-Part III: Energy induced deposition and hybrid electrochemical processes.” Precision Engineering 68 (2021): 174-186.
122. Deppisch, C., et al., “The material optimization and reliability characterization of an indium-solder thermal interface material for CPU packaging,” JOM, vol. 58, no. 6, pp. 67-74, June 2006, doi: 10.1007/s11837-006-0186-6.
123. Erlebacher, J., M. J. Aziz, A. Karma, N. Dimitrov, and K. Sieradzki, “Evolution of nanoporosity in dealloying,” Nature, vol. 410, no. 6827, Art. no. 6827 March 2001, doi: 10.1038/35068529.
124. Frank, Madeline, Michael Matthews, Joseph Madril, and Ian Winfield. “Electrochemical Additive Manufacturing: A Novel Approach To Thermal Management Of Electronics.” In 2023 IEEE 73rd Electronic Components and Technology Conference (ECTC), pp. 432-436. IEEE, 2023.
125. Hamzah, Hairul Hisham, Saiful Arifin Shafiee, Aya Abdalla, and Bhavik Anil Patel. “3D printable conductive materials for the fabrication of electrochemical sensors: A mini review.” Electrochemistry Communications 96 (2018): 27-31.
126. Schiffres, S. N., A. Azizi, Additive manufacturing processes and additively manufactured products, U.S. Pat. No. 11,167,375 B2, 2021 and US 2020/0047288 A1, 2020.
127. Mercelis, P., J. Kruth, Residual stresses in selective laser sintering and selective laser melting, Rapid Prototyping Journal. 12 (2006) 254-265. doi.org/10.1108/13552540610707013.
128. Huang, C. A., S. W. Yang, C. H. Shen, K. C. Cheng, H. Wang, and P. L. Lai, “Fabrication and evaluation of electroplated Ni-diamond and Ni—B-diamond milling tools with a high density of diamond particles,” Int. J. Adv. Manuf. Technol., vol. 104, no. 5, pp. 2981-2989 October 2019, doi: 10.1007/s00170-019-04174-3.
129. Kamaraj, Abishek, Spenser Lewis, and Murali Sundaram. “Numerical study of localized electrochemical deposition for micro electrochemical additive manufacturing.” Procedia CIRP 42 (2016): 788-792.
130. Lamotte-Dawaghreh, Jacob, Joseph Herring, Sai Pundla, Rohit Suthar, Vivek Nair, Pratik Bansode, Gautam Gupta et al. “Electrochemical Additive Manufacturing Based Design of a Heat Sink for Single Phase Natural Convection Immersion Cooling Application.” In International Electronic Packaging Technical Conference and Exhibition, vol. 87516, p. V001T01A006. American Society of Mechanical Engineers, 2023.
131. Lee, H., et al., “Enhanced Heat Transfer Using Microporous Copper Inverse Opals,” J. Electron. Packag., vol. 140, no. 020906, May 2018, doi: 10.1115/1.4040088.
132. Liu, Yang, Jinzhong Lu, Wei Xue, Zhaoyang Zhang, Hao Zhu, Kun Xu, Yucheng Wu, Bo Wang, and Weining Lei. “A strategy for fabricating multi-level micro-nano superamphiphobic surfaces by laser-electrochemistry subtractive-additive hybrid manufacturing method.” Colloids and Surfaces A: Physicochemical and Engineering Aspects 663 (2023): 130946.
133. Madden, J. D., and I. W. Hunter, “Three-dimensional microfabrication by localized electrochemical deposition,” J. Microelectromechanical Syst., vol. 5, no. 1, pp. 24-32, March 1996, doi: 10.1109/84.485212.
134. McCue, I., E. Benn, B. Gaskey, and J. Erlebacher, “Dealloying and Dealloyed Materials,” Annu. Rev. Mater. Res., vol. 46, no. 1, pp. 263-286, 2016, doi: 10.1146/annurev-matsci-070115-031739.
135. Moghaddam, Saeed, John Lawler, and Michael Ohadi. Liquid cooled diamond bearing heat sink. United States U.S. Pat. No. 7,215,545B1, filed Apr. 27, 2004, and issued May 8, 2007.
136. Nelson, Jeffrey B., and Daniel T. Schwartz. “Characterization of buffered electrolytes for nickel electrochemical printing.” Journal of the Electrochemical Society 155, no. 3 (2008): D181.
137. Sapoletova, N., et al., “Controlled growth of metallic inverse opals by electrodeposition,” Phys. Chem. Chem. Phys., vol. 12, no. 47, pp. 15414-15422, 2010, doi: 10.1039/C0CP00812E.
138. Schiffres, S. N., and A. Azizi, “Additive manufacturing processes and additively manufactured products,” US20200047288A1, Feb. 13, 2020
139. Siddiqui, Hafsa, Netrapal Singh, Diksha Katiyar, Palash Naidu, Shivi Mishra, Harish Chandra Prasad, Mohd Akram Khan, Mohammad Ashiq, N. Sathish, and Surender Kumar. “Electrochemical additive manufacturing (ECAM): A new approach to fabricate metal nanostructures.” Materials Today: Proceedings 72 (2023): 2741-2748.
140. Siddiqui, Hafsa, Netrapal Singh, Palash Naidu, Koyalada Bhavani Srinivas Rao, Shaily Gupta, Avanish Kumar Srivastava, M. S. Santosh et al. “Emerging electrochemical additive manufacturing technology for advanced materials: Structures and applications.” Materials Today (2023).
141. Singh, Mithilesh, Shalini Mohanty, and Alok Kumar Das. “Parametric analysis to enhance the printability in metal with electrochemical additive manufacturing.” Materials Letters 322 (2022): 132518.
142. Sundaram, Murali M., Abishek B. Kamaraj, and Varun S. Kumar. “Mask-less electrochemical additive manufacturing: a feasibility study.” Journal of Manufacturing Science and Engineering 137, no. 2 (2015): 021006.
143. Sundaram, Murali, Abishek B. Kamaraj, and Grace Lillie. “Experimental study of localized electrochemical deposition of Ni—Cu alloy using a moving anode.” Procedia CIRP 68 (2018): 227-231.
144. Tsubota, T., S. Tanii, T. Ishida, M. Nagata, and Y. Matsumoto, “Composite electroplating of Ni and surface-modified diamond particles with silane coupling regent,” Diam. Relat. Mater., vol. 14, no. 3, pp. 608-612, March 2005, doi: 10.1016/j.diamond.2005.01.013.
145. van Nisselroy, Cathelijn, Chunjian Shen, Tomaso Zambelli, and Dmitry Momotenko. “Electrochemical 3D printing of silver and nickel microstructures with FluidFM.” Additive Manufacturing 53 (2022): 102718.
146. Vervald, A. M., et al., “Nanodiamonds and surfactants in water: Hydrophilic and hydrophobic interactions,” J. Colloid Interface Sci., vol. 547, pp. 206-216, July 2019, doi: 10.1016/j.jcis.2019.03.102. www.sciencedirect.com/science/article/abs/pii/S0021979719304084
147. Whitaker, J. D., J. B. Nelson, and D. T. Schwartz. “Electrochemical printing: software reconfigurable electrochemical microfabrication.” Journal of Micromechanics and Microengineering 15, no. 8 (2005): 1498.
148. Whitaker, John D. “Electrochemical printing.” (2003).
149. Whittingham, Matthew J., Robert D. Crapnell, Emma J. Rothwell, Nicholas J. Hurst, and Craig E. Banks. “Additive manufacturing for electrochemical labs: An overview and tutorial note on the production of cells, electrodes and accessories.” Talanta Open 4 (2021): 100051.
150. Winfield, Ian, Joseph Madril, Tim Ouradnik, Michael Matthews, and Guillermo Romero. “FABRIC8LABS: Electrochemical Additive Manufacturing (ECAM) For Cooling High Performance ICs.” In 2023 IEEE Hot Chips 35 Symposium (HCS), pp. 1-18. IEEE Computer Society, 2023.
151. Wu, Y., et al., “Critical effect and enhanced thermal conductivity of Cu-diamond composites reinforced with various diamond prepared by composite electroplating,” Ceram. Int., vol. 45, no. 10, pp. 13225-13234, July 2019, doi: 10.1016/j.ceramint.2019.04.008.
152. Ye, Peng, Qibin Niu, and Fuliang Wang. “Effect of electrolyte composition and deposition voltage on the deposition rate of copper microcolumns jet electrodeposition.” Materials Science and Engineering: B 298 (2023): 116857.
153. Crapnell, Robert D., Cristiane Kalinke, Luiz Ricardo G. Silva, Jéssica S. Stefano, Rhys J. Williams, Rodrigo Alejandro Abarza Munoz, Juliano A. Bonacin, Bruno C. Janegitz, and Craig E. Banks. “Additive manufacturing electrochemistry: an overview of producing bespoke conductive additive manufacturing filaments.” Materials Today 71 (2023): 73-90.
154. Ayalew, Adane Adugna, Xiaole Han, and Masatoshi Sakairi. “A critical review of additive material manufacturing through electrochemical deposition techniques.” Additive Manufacturing 77 (2023): 103796.
155. Kruth, J. P., L. Froyen, J. Van Vaerenbergh, P. Mercelis, M. Rombouts, B. Lauwers, Selective laser melting of iron-based powder, Journal of Materials Processing Technology. 149 (2004) 616-622. doi.org/10.1016/j.jmatprotec.2003.11.051.
156. Crapnell, Robert D., Cristiane Kalinke, Luiz Ricardo G. Silva, Jéssica S. Stefano, Rhys J. Williams, Rodrigo Alejandro Abarza Munoz, Juliano A. Bonacin, Bruno C. Janegitz, and Craig E. Banks. “Additive manufacturing electrochemistry: an overview of producing bespoke conductive additive manufacturing filaments.” Materials Today 71 (2023): 73-90.
157. Ayalew, Adane Adugna, Xiaole Han, and Masatoshi Sakairi. “A critical review of additive material manufacturing through electrochemical deposition techniques.” Additive Manufacturing 77 (2023): 103796.
158. Hengsteler, Julian, Karuna Aurel Kanes, Liaisan Khasanova, and Dmitry Momotenko. “Beginner's guide to micro- and nanoscale electrochemical additive manufacturing.” Annual Review of Analytical Chemistry 16, no. 1 (2023): 71-91
159. Rajesh, Singuru, and Adhidesh S. Kumawat. “Integrating additive manufacturing approaches in electrochemistry for enhanced systems-a mini review.” Ionics 30, no. 2 (2024): 677-687.
162. Anthony, T. R.; Banholzer, W. F.; Fleischer, J. F.; Wei, Lanhua; et al. (1990). “Thermal conductivity of isotopically enriched 12C diamond”. Physical Review B. 42 (2): 1104-1111. Bibcode: 1990PhRvB . . . 42.1104A. doi: 10.1103/PhysRevB.42.1104. PMID 9995514.
163. Wei, Lanhua; Kuo, P. K.; Thomas, R. L.; Anthony, T. R.; Banholzer, W. F. (1993). “Thermal conductivity of isotopically modified single crystal diamond”. Physical Review Letters. 70 (24): 3764-3767. Bibcode: 1993PhRvL . . . 70.3764 W. doi: 10.1103/PhysRevLett.70.3764. PMID 10053956.
164. Cho, Hai Jun, Dong Yan, Jason Tam, and Uwe Erb. “Effects of diamond particle size on the formation of copper matrix and the thermal transport properties in electrodeposited copper-diamond composite materials.” Journal of Alloys and Compounds 791 (2019): 1128-1137.
165. Zhang, Y., H. L. Zhang, J. H. Wu, and X. T. Wang. “Enhanced thermal conductivity in copper matrix composites reinforced with titanium-coated diamond particles.” Scripta Materialia 65, no. 12 (2011): 1097-1100.
166. Carroll, Gregory T.; Lancaster, Jeffrey R.; Turro, Nicholas J.; Koberstein, Jeffrey T.; Mammana, Angela (2017). “Electroless Deposition of Nickel on Photografted Polymeric Microscale Patterns”. Macromolecular Rapid Communications. 38 (2): 1600564. doi: 10.1002/marc.201600564IF: 4.2 Q2. PMID 27873447IF: 4.2 Q2.
167. Muench, Falk (2021-08-13). “Electroless Plating of Metal Nanomaterials”. ChemElectroChem. 8 (16): 2993-3012. doi: 10.1002/celc.202100285IF: 3.5 Q2. ISSN 2196-0216. S2CID 235509471.
168. Modern electroplating. Milan Paunovic, Mordechay Schlesinger (5 ed.). Hoboken, NJ: Wiley. 2010. ISBN 978-0-470-16778-6. OCLC 792932606.
169. Aminu, Temitope Q.; Juybari, Hamid Fattahi; Warsinger, David M.; Bahr, David F. (2024-09-20). “Electroless Deposition for Robust and Uniform Copper Nanoparticles on Electrospun Polyacrylonitrile (PAN) Microfiltration Membranes”. Membranes. 14 (9): 198. doi: 10.3390/membranes 14090198IF: 3.3 Q2. ISSN 2077-0375. PMC 11434320. PMID 39330539IF: 3.3 Q2.
170. G. O. Mallory and J. B. Hajdu, editors (1990): Electroless plating: fundamentals and applications. 539 pages. ISBN 9780936569079
171. Siddikali, Palaiam; Sreckanth, P. S. Rama (2022-08-18). “Performance Evaluation of CNT Reinforcement on Electroless Plating on Solid Free-Form-Fabricated PETG Specimens for Prosthetic Limb Application”. Polymers. 14 (16): 3366. doi: 10.3390/polym14163366IF: 4.7 Q1. ISSN 2073-4360. PMC 9415912. PMID 36015623IF: 4.7 Q1.
172. Electro-Coating. “Differences & Advantages Between Electroplating & Electroless Plating|Electro-Coating”. www.electro-coatings.com. Retrieved 2023 Feb. 24.
173. Zhang, B. (2016). Amorphous and Nano Alloys Electroless Depositions. Washington State University Pullman.
174. Afzali, Arezoo; Mottaghitalab, Vahid; Motlagh, Mahmood Saberi; Haghi, Akbar Khodaparast (2010-07-01). “The electroless plating of Cu—Ni—P alloy onto cotton fabrics”. Korean Journal of Chemical Engineering. 27 (4): 1145-1149. doi: 10.1007/s11814-010-0221-8IF: 2.9 Q2. ISSN 1975-7220. S2CID 55179900.
175. Ali, Azam; Baheti, Vijay; Vik, Michal; Militky, Jiri (2020). “Copper electroless plating of cotton fabrics after surface activation with deposition of silver and copper nanoparticles”. Journal of Physics and Chemistry of Solids. 137:109181. Bibcode: 2020JPCS . . . 13709181A. doi: 10.1016/j.jpcs.2019.109181IF: 4.3 Q2. ISSN 0022-3697. S2CID 202883768.
176. Cotell, C. M.; Sprague, J. A.; Smidt, F. A., eds. (1994), “Electroless Copper Plating”, Surface Engineering, ASM International, pp. 311-322, doi: 10.31399/asm.hb.v05.a0001265, ISBN 978-1-62708-170-2, OSTI 872041, retrieved 2023 Feb. 23
177. Viswanathan, B. (1994), “Metallization of Plastics by Electroless Plating”, Microwave Materials, Berlin, Heidelberg: Springer Berlin Heidelberg, pp. 79-99, doi: 10.1007/978-3-662-08740-4_3, ISBN 978-3-662-08742-8, retrieved 2023 Feb. 22
178. Krulik, G. A. (1976). “Electroless plating of plastics”. Journal of Chemical Education. 55 (6): 361. doi: 10.1021/ed055p361IF: 2.5 Q2. ISSN 0021-9584.
179. Jiang, S. Q.; Newton, E.; Yuen, C. W. M.; Kan, C. W. (2006). “Chemical Silver Plating on Cotton and Polyester Fabrics and its Application on Fabric Design”. Textile Research Journal. 76 (1): 57-65. doi: 10.1177/0040517506053827IF: 1.6 Q2. ISSN 0040-5175. S2CID 137801241.
180. U.S. Patent and Published Patent Application Nos. 7592964; 7977599; 9186726; 9248501; 9254535; 9346127; 9399256; 9403235; 9486878; 9573193; 9573225; 9586290; 9662840; 9676145; 9700258; 9777385; 9777385; 9821411; 9919360; 9931697; 9953899; 9962767; 10058920; 10065270; 10071422; 10096537; 10183330; 10195693; 10207454; 10222436; 10226894; 10252335; 10252336; 10253836; 10259044; 10286452; 10286603; 10315252; 10357829; 10357957; 10369629; 10407790; 10415394; 10421265; 10431393; 10434573; 10442003; 10449696; 10465307; 10465307; 10493564; 10501857; 10507549; 10549246; 10611092; 10639134; 10648082; 10661341; 10665530; 10673288; 10688722; 10722947; 10722947; 10724146; 10724146; 10724467; 10731259; 10781524; 10808322; 10808794; 10840605; 10844504; 10859330; 10888925; 10914000; 10914000; 10947632; 10947632; 10948108; 10957624; 10961635; 10975485; 10975485; 10987868; 11008664; 11008664; 11014288; 11052460; 11084718; 11118280; 11161744; 11168408; 11180864; 11214884; 11232956; 11232956; 11242613; 11285642; 11286575; 11293272; 11313035; 11313035; 11313036; 11313036; 11313045; 11365488; 11371154; 11371154; 11381006; 11390960; 11396710; 11396710; 11401603; 11401603; 11440246; 11456235; 11460356; 11482793; 11512404; 11512404; 11519093; 11521864; 11521864; 11524213; 11524385; 11535947; 11542605; 11548067; 11560629; 11576766; 11591705; 11591705; 11618079; 11618213; 11633830; 11655553; 11680330; 11691343; 11692281; 11701709; 11707887; 11718115; 11745432; 11784384; 11795561; 11795561; 11801369; 11801426; 11823895; 11833638; 20040107019; 20070115198; 20090101629; 20140087210; 20150218360; 20150290878; 20150367415; 20150367416; 20150367417; 20150367418; 20150367419; 20150367446; 20150367447; 20150367448; 20160015311; 20160121399; 20160175787; 20160207109; 20160288200; 20160297006; 20160297007; 20160312617; 20160339517; 20170021420; 20170023084; 20170044680; 20170050379; 20170059676; 20170092565; 20170129052; 20170129184; 20170129185; 20170144254; 20170145578; 20170145578; 20170145584; 20170145584; 20170165751; 20170165752; 20170165753; 20170165754; 20170165792; 20170189963; 20170217095; 20170239719; 20170239720; 20170239721; 20170239752; 20170239891; 20170239892; 20170291372; 20170304894; 20170304944; 20170334024; 20170341183; 20170355146; 20170355147; 20180001553; 20180001556; 20180001557; 20180056391; 20180065186; 20180071980; 20180071986; 20180093418; 20180093419; 20180095450; 20180099869; 20180111319; 20180117845; 20180126460; 20180126461; 20180126462; 20180126649; 20180126650; 20180128202; 20180128203; 20180133801; 20180133956; 20180141126; 20180154442; 20180154443; 20180161875; 20180178461; 20180179644; 20180183279; 20180186067; 20180186080; 20180186081; 20180186082; 20180214944; 20180250744; 20180250745; 20180250746; 20180250771; 20180250772; 20180250773; 20180250774; 20180250775; 20180261394; 20180281236; 20180281237; 20180281282; 20180281283; 20180281284; 20180318928; 20180319150; 20180320801; 20180326488; 20180337110; 20180368961; 20190017185; 20190055661; 20190061002; 20190118263; 20190118423; 20190143412; 20190145726; 20190190111; 20190190160; 20190190161; 20190210280; 20190224919; 20190229038; 20190291184; 20190301034; 20190301034; 20190314896; 20190322052; 20190330064; 20200004225; 20200008316; 20200131661; 20200133235; 20200139631; 20200173032; 20200214817; 20200232109; 20200255791; 20200261239; 20200276019; 20200289710; 20200308716; 20200335425; 20200354220; 20200384606; 20200408616; 20210047745; 20210054498; 20210054498; 20210054516; 20210054516; 20210063099; 20210090901; 20210090901; 20210098341; 20210098889; 20210102286; 20210102286; 20210146439; 20210147992; 20210154732; 20210155023; 20210171401; 20210196332; 20210220909; 20210245395; 20210269450; 20210276096; 20210299816; 20210299817; 20210301413; 20210301414; 20210301414; 20210308762; 20210340334; 20210348288; 20210348288; 20210388520; 20210388521; 20210402556; 20220032023; 20220081760; 20220081760; 20220081761; 20220081761; 20220081792; 20220081792; 20220081794; 20220081794; 20220084840; 20220084840; 20220115230; 20220143900; 20220151515; 20220162765; 20220162765; 20220175413; 20220176096; 20220234259; 20220250328; 20220266340; 20220267153; 20220267919; 20220297186; 20220297401; 20220339822; 20220349046; 20220349046; 20220364252; 20220379381; 20220380922; 20220388065; 20220416437; 20230029051; 20230030232; 20230031781; 20230031781; 20230040341; 20230046685; 20230059846; 20230059846; 20230065517; 20230066285; 20230070048; 20230070048; 20230079336; 20230079959; 20230079959; 20230088962; 20230088962; 20230089135; 20230089135; 20230096368; 20230111191; 20230122002; 20230129434; 20230149143; 20230150030; 20230150204; 20230166381; 20230182398; 20230191094; 20230191490; 20230193494; 20230193494; 20230207426; 20230221611; 20230226759; 20230226760; 20230234282; 20230272545; 20230273076; 20230286211; 20230304179; 20230304179; 20230311269; 20230312337; 20230330940; 20230340683; 20230340683; 20230364861; 20230390826; 20230394161; and 20230398604.
179. US Patent and Published Patent Application Nos. 4431989; 5799393; 6015082; 6193139; 6258239; 8574744; 9793056; 10470314; 10734582; 20040107019; 20040112754; 20050106474; 20080132082; 20090084159; 20090242414; 20090314647; 20100009234; 20100044233; 20100116678; 20100273085; 20100326834; 20110022162; 20110024302; 20130168254; 20140339092; 20150249163; 20150311359; 20160197356; 20160247960; 20170145584; 20170250295; 20170271649; 20180178461; 20180261394; 20190153581; 20190256995; 20190379007; 20210348288; 20210388520; 20210388521; 20220175278; 20220305587; 20220406529; 20230031781; 20230086742; 20230193494; 20240044030; 20240052512; 20240084473; 20240179847; 20240384397; 20250044684; and 20250059667.

What is claimed is:

1. A structure, comprising:
a composite, containing inclusions bonded by a solid material formed by reduction or oxidation of ions in solution; and
a strike layer of a thermally dissipative substrate, configured to enhance at least one of formation and adhesion of the composite on the strike layer.

2. The structure according to claim 1, wherein the material is formed by a current flowing through the strike layer to cause electrochemical deposition.

3. The structure according to claim 1, wherein the composite is formed in a spatially-selective manner as a series of superposed incomplete layers.

4. The structure according to claim 1, wherein the inclusions comprise solid particles configured to increase the heat dissipation rate and reduce the coefficient of thermal expansion of the composite.

5. The structure according to claim 1, wherein the thermally dissipative substrate comprises a patterned semiconductor material integrated circuit.

6. The structure according to claim 1, wherein the inclusions comprise at least one of diamond, graphite, carbon nanotubes, graphene, and boron nitride.

7. The structure according to claim 6, wherein the inclusions further comprise an interlayer of a carbide selected from the group consisting of nickel carbide, cobalt carbide, chromium carbide, zirconium carbide, and boron carbide.

8. The structure according to claim 1, wherein the material is a metal, and the inclusions comprise metal particles.

9. The structure according to claim 1, wherein the material is a spatially selective configuration of a metal and the inclusions are non-metallic particles coated with an interlayer having an intermediate Debye temperature with respect to the metal and the non-metallic particles.

10. The structure according to claim 1, wherein the structure is configured to have interconnected porosity.

11. The structure according to claim 1, wherein the inclusions principally have a mass average diameter of between 10 and 500 microns in diameter.

12. The structure according to claim 1, wherein the structure comprises a heatsink, further comprising a ductile metal layer between the strike layer and the composite.

13. The structure according to claim 1, wherein the strike layer comprises an adhesion layer selected from the group consisting of Ti, Cr, V, Ni, TiN, Ta, TaN, Mo, TiW.

14. The structure according to claim 1, wherein the composite is formed in a spatially-selective pattern with stress reducing gaps.

15. The structure according to claim 1, wherein the composite comprises at least one of metallic copper, silver, gold, and aluminum, and the particles comprise metallized diamond particles.

16. The structure according to claim 1, wherein the spatially-selective electrochemically bonded composite structure has an artery-capillary structure.

17. The structure according to claim 1, further comprising a polymeric manifold system configured to contain a flow of a heat transfer fluid.

18. A method of forming a structure on a substrate comprising forming a composite by reduction or oxidation of ions in a solution to a solid matrix surrounding inclusions suspended in the solution, on a strike layer of a substrate.

19. The method according to claim 18, wherein the solid matrix is a metal, and the inclusions comprise solid particles configured to increase a thermal transfer rate and reduce a coefficient of thermal expansion of composite.

20. The method according to claim 18, further comprising applying a mask to the substrate, forming the composite with spatial constraints imposed by the mask, and removing the mask after formation of the composite with the spatial constraints.

21. The method according to claim 18, wherein the forming of the composite comprises periodically sedimenting solid particles suspended in the solution, and periodically electroplating the solid matrix with electroplating pulses to surround the sedimented particles with the solid matrix.

22. A heat dissipation device having a sealed cooling fluid path, having an internal coating on the sealed cooling fluid path comprising an electrochemically or electroless formed metallic film configured to impede coolant leakage from the sealed cooling fluid path.
